(19) United States
(12) Patent Application Publication
(10) Pub. No.: US 2010/0296798 A1
(43) Pub. Date: Nov. 25, 2010

(54) Image Reproducing Apparatus And Imaging Apparatus

(75) Inventor: Kanichi KOYAMA, Higashiosaka City (JP)

Correspondence Address: NDQ&M WATCHSTONE LLP, 300 NEW JERSEY AVENUE, NW, FIFTH FLOOR, WASHINGTON, DC, 20001, US

(73) Assignee: SANYO ELECTRIC CO., LTD., Osaka (JP)

(21) Appl. No.: 12/783,892

(22) Filed: May 20, 2010

(30) Foreign Application Priority Data
May 22, 2009 (JP) 2009-123958
Apr. 9, 2010 (JP) 2010-090213

(51) Int. Cl. H04N 5/91

(52) U.S. Cl. 386/343; 386/E05.003

(57) ABSTRACT

An image reproducing apparatus which reproduces a moving image includes a reproducing speed control unit which controls a reproducing speed of the moving image in accordance with an evaluation distance that is a distance between a plurality of specific objects in the moving image or a distance between a fixed position and a target object in the moving image.

### CROSS-REFERENCE TO RELATED APPLICATIONS

This nonprovisional application claims priority under 35 U.S.C. §119(a) on Patent Application No. 2009-123958 filed in Japan on May 22, 2009 and on Patent Application No. 2010-090213 filed in Japan on Apr. 9, 2010, the entire contents of which are hereby incorporated by reference.

### BACKGROUND OF THE INVENTION

1. Field of the Invention

The present invention relates to an image reproducing apparatus for reproducing images, and an imaging apparatus such as a digital camera.

2. Description of Related Art

When a moving image of a soccer game or a track event is reproduced, it is often desired to play in slow motion in an important scene like a scene where soccer players are scrambling for a ball or a goal scene in a track event. In addition, without limiting to a soccer game or a track event, it is often desired to play in slow motion to see an important scene in various moving images. However, it is tiresome for a user to set an optimal reproducing speed to the important scene every time in reproduction of a moving image.

There is considered a method of discriminating presence or absence of a motion of an object on the image by utilizing a difference between frames, or the like, so that an image section having a motion of the object is played in slow motion automatically. However, too many slow motion play sections may be set in this method responding to every object having a motion, so that the image may become hard to see on the contrary.

Note that there is disclosed a conventional method of detecting a slow motion play section utilizing a difference between frames. However, this conventional method is a method in which the slow motion play section is inserted in video data (e.g., the slow motion play section is inserted in video data for broadcasting program by an editor of the program in advance), and a reproducing apparatus detects and extracts the slow motion play section. Therefore, it does not contribute to realizing an appropriate reproducing speed.

### SUMMARY OF THE INVENTION

An image reproducing apparatus according to the present invention is an image reproducing apparatus which reproduces a moving image and includes a reproducing speed control unit which controls a reproducing speed of the moving image in accordance with an evaluation distance that is a distance between a plurality of specific objects in the moving image or a distance between a fixed position and a target object in the moving image.

Another image reproducing apparatus according to the present invention is an image reproducing apparatus which reproduces a moving image and includes a reproducing speed control unit which controls a reproducing speed of the moving image in accordance with at least one of orientation and inclination of a person's face in the moving image.

Still another image reproducing apparatus according to the present invention is an image reproducing apparatus which reproduces a moving image and includes a reproducing speed control unit which controls a reproducing speed of the moving image in accordance with a magnitude of a sound signal associated with the moving image.

In addition, an imaging apparatus according to the present invention is an imaging apparatus which performs image sensing and recording of a moving image and includes a frame rate control unit which controls a frame rate of the moving image to be recorded in accordance with an evaluation distance that is a distance between a plurality of specific objects in the moving image or a distance between a fixed position and a target object in the moving image.

In addition, another imaging apparatus according to the present invention is an imaging apparatus which performs image sensing and recording of a moving image and includes a frame rate control unit which controls a frame rate of the moving image to be recorded in accordance with at least one of orientation and inclination of a person's face in the moving image.

In addition, still another imaging apparatus according to the present invention is an imaging apparatus which performs image sensing and recording of a moving image and includes a frame rate control unit which controls a frame rate of the moving image to be recorded in accordance with a magnitude of a sound signal collected when the image sensing of the moving image is performed.

Meanings and effects of the present invention will be further apparent from the following description of embodiments. However, the embodiments described below are merely examples of the present invention. Meanings of terms in the present invention and individual elements thereof are not limited to those described in the following description of the embodiments.

### BRIEF DESCRIPTION OF THE DRAWINGS

FIG. 1 is a general block diagram of an imaging apparatus according to a first embodiment of the present invention.

FIG. 2 is a partial block diagram of the imaging apparatus according to the first embodiment of the present invention, which is related particularly to an operation in an automatic slow motion play mode.

FIG. 3 is a diagram illustrating an input frame image sequence which forms an input moving image.

FIG. 4 is a diagram illustrating an input frame image and two tracking targets on the input frame image according to the first embodiment of the present invention.

FIG. 5 is a diagram illustrating a first relationship between an evaluation distance and a reproducing speed adjustment ratio according to the first embodiment of the present invention.

FIGS. 6A and 6B are diagrams illustrating the input frame images, in which a distance between two tracking targets is small in FIG. 6A while the distance is large in FIG. 6B.

FIG. 7 is a diagram illustrating a second relationship between an evaluation distance and a reproducing speed adjustment ratio according to the first embodiment of the present invention.

FIG. 8 is a diagram illustrating a relationship between an input frame image sequence and an output frame image sequence according to the first embodiment of the present invention.

FIG. 9 is a diagram illustrating a relationship between an input frame image sequence and an output frame image sequence according to the first embodiment of the present invention.

FIG. 10 is a flowchart of an operation of the imaging apparatus in an automatic slow motion play mode according to the first embodiment of the present invention.

FIG. 11 is a diagram illustrating an input frame image and a tracking target as well as a fixed position on the input frame image according to a second embodiment of the present invention.

FIG. 12 is a partial block diagram of the imaging apparatus related particularly to an operation in an automatic slow motion recording mode according to a fourth embodiment of the present invention.

FIG. 13 is a diagram illustrating a relationship between an evaluation distance and an image sensing rate (frame rate in image sensing) according to the fourth embodiment of the present invention.

FIG. 14 is a flowchart of an operation of the imaging apparatus in the automatic slow motion recording mode according to the fourth embodiment of the present invention.

FIG. 15 is a partial block diagram of the imaging apparatus related particularly to an operation in the automatic slow motion play mode according to a sixth embodiment of the present invention.

FIGS. 16A to 16E are diagrams illustrating the sixth embodiment of the present invention, in which FIG. 16A illustrates a front face, FIGS. 16B and 16D illustrate diagonal faces, and FIGS. 16C and 16E illustrate side faces.

FIG. 17 is a diagram for illustrating a facial inclination angle according to the sixth embodiment of the present invention.

FIG. 18 is a diagram illustrating a manner where a noted area on an input frame image is scanned according to the sixth embodiment of the present invention.

FIG. 19 is a diagram illustrating 45 types of reference face images according to the sixth embodiment of the present invention.

FIG. 20 is a diagram illustrating an example of a relationship between an evaluation angle and the reproducing speed adjustment ratio according to the sixth embodiment of the present invention.

FIG. 21 is a flowchart of an operation of the imaging apparatus in the automatic slow motion play mode according to the sixth embodiment of the present invention.

FIG. 22 is a partial block diagram of the imaging apparatus related particularly to an operation in the automatic slow motion recording mode according to a seventh embodiment of the present invention.

FIG. 23 is a diagram illustrating a relationship between the evaluation angle and the image sensing rate (frame rate in image sensing) according to the seventh embodiment of the present invention.

FIG. 24 is a flowchart of an operation of the imaging apparatus in the automatic slow motion recording mode according to the seventh embodiment of the present invention.

FIG. 25 is a partial block diagram of the imaging apparatus related particularly to an operation in the automatic slow motion play mode according to an eighth embodiment of the present invention.

FIG. 26 is a diagram illustrating a manner where a whole image sensing section of the input moving image is divided into a plurality of unit sections according to the eighth embodiment of the present invention.

FIG. 27 is a diagram illustrating an example of a relationship between an evaluation sound volume and the reproducing speed adjustment ratio according to the eighth embodiment of the present invention.

FIG. 28 is a flowchart of an operation of the imaging apparatus in the automatic slow motion play mode according to the eighth embodiment of the present invention.

FIG. 29 is a partial block diagram of the imaging apparatus related particularly to an operation in the automatic slow motion recording mode according to a ninth embodiment of the present invention.

FIG. 30 is a diagram illustrating a relationship between the evaluation sound volume and the image sensing rate (frame rate in image sensing) according to the ninth embodiment of the present invention.

FIG. 31 is a flowchart of an operation of the imaging apparatus in the automatic slow motion recording mode according to the ninth embodiment of the present invention.

FIG. 32 is a partial block diagram of the imaging apparatus related particularly to an operation in the automatic slow motion recording mode according to a tenth embodiment of the present invention.

FIG. 33 is a diagram illustrating a summary of the first to the tenth embodiments of the present invention.

### DETAILED DESCRIPTION OF THE PREFERRED EMBODIMENTS

Hereinafter, embodiments of the present invention will be specifically described with reference to the attached drawings. In the drawings to be referred to, the same part is denoted by the same reference numeral so that overlapping description of the same part will be omitted as a rule. FIG. 33 is a diagram illustrating a summary of a first to a tenth embodiments described below.

### First Embodiment

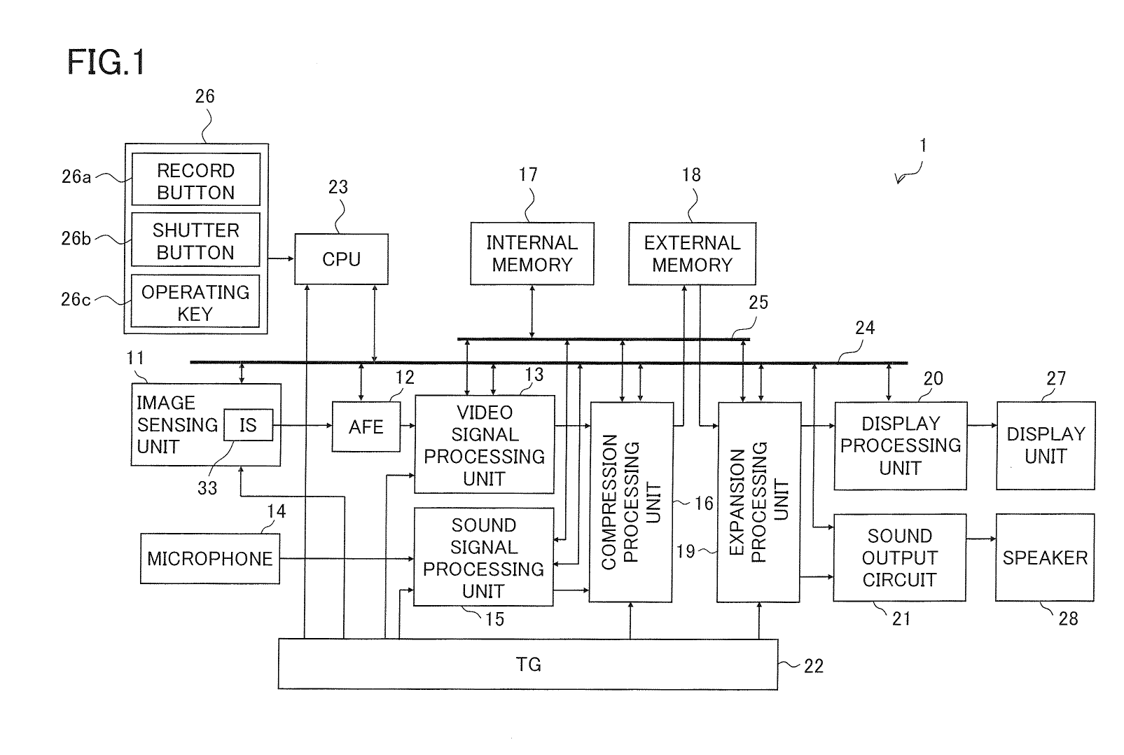

The first embodiment of the present invention will be described. FIG. 1 is a general block diagram of an imaging apparatus 1 according to the first embodiment of the present invention. The imaging apparatus 1 includes individual units denoted by numerals 11 to 28. The imaging apparatus 1 is a digital video camera, which is capable to taking moving images and still images. It is also capable of taking a still image while taking a moving image at the same time. The individual units in the imaging apparatus 1 communicate signals (data) through a bus 24 or 25 between units. Note that a display unit 27 and/or a speaker 28 may be disposed in an external apparatus (not shown) outside the imaging apparatus 1.

An image sensing unit 11 has an image sensor 33 and other members (not shown) including an optical system, an aperture stop and a driver. The image sensor 33 is constituted of a plurality of light receiving pixels arranged in the horizontal and the vertical directions. The image sensor 33 is a solid-state image sensor constituted of a charge coupled device (CCD), a complementary metal oxide semiconductor (CMOS) image sensor, or the like. Each light receiving pixel of the image sensor 33 performs photoelectric conversion of an optical image of a subject entering through the optical system and the aperture stop, and an electric signal obtained by the photoelectric conversion is output to an analog front end (AFE) 12. Individual lenses constituting the optical system form an optical image of a subject on the image sensor 33.

The AFE 12 amplifies an analog signal output from the image sensor 33 (individual light receiving pixels), and the amplified analog signal is converted into a digital signal and is output to a video signal processing unit 13. An amplification degree of the AFE 12 for amplifying the signal is controlled by a central processing unit (CPU) 23. The video signal processing unit 13 performs necessary image processing on the image expressed by the output signal of the AFE 12, so as to generate a video signal of an image after the image processing. A microphone 14 converts sounds around the imaging apparatus 1 into an analog sound signal, and a sound signal processing unit 15 converts this analog sound signal into a digital sound signal.

A compression processing unit 16 compresses the video signal from the video signal processing unit 13 and the sound signal from the sound signal processing unit 15 by using a predetermined compression method. An internal memory 17 is constituted of a dynamic random access memory (DRAM) or the like and stores temporarily various data. An external memory 18 as a recording medium is a nonvolatile memory such as a semiconductor memory or a magnetic disk and stores the video signal and the sound signal in association with each other after the compression processing unit 16 compresses them.

An expansion processing unit 19 expands the compressed video signal and sound signal read out from the external memory 18. The video signal after the expansion process by the expansion processing unit 19 or the video signal from the video signal processing unit 13 is sent through a display processing unit 20 to the display unit 27 constituted of a liquid crystal display or the like and is displayed as an image. In addition, the sound signal after the expansion process by the expansion processing unit 19 is sent through a sound output circuit 21 to the speaker 28 and is output as sound.

A timing generator (TG) 22 generates a timing control signal for controlling timings of individual operations in the entire imaging apparatus 1 and supplies the generated timing control signal to the individual units in the imaging apparatus 1. The timing control signal includes a vertical synchronizing signal Vsync and a horizontal synchronizing signal Hsync. A CPU 23 controls operations of the individual units of the imaging apparatus 1 integrally. An operating unit 26 includes a record button 26a for instructing start and stop of image sensing and recording of a moving image, a shutter button 26b for instructing image sensing and record of a still image and an operating key 26c, and the like, so as to accept various operations from a user. The operation to the operating unit 26 is transmitted to the CPU 23.

Operation modes of the imaging apparatus 1 includes an image sensing mode in which an image (still image or moving image) can be sensed and recorded and a reproducing mode in which an image (still image or moving image) recorded in the external memory 18 is reproduced and displayed on the display unit 27. Switching between the modes is performed responding to the operation to the operating key 26c. When the imaging apparatus 1 operates in the reproducing mode, it functions as an image reproducing apparatus.

In the image sensing mode, image sensing of a subject is performed periodically at a predetermined frame period, so that taken images of the subject is sequentially obtained. A digital video signal expressing an image is also referred to as image data. The image data of one frame period expresses a frame of image. A frame of image expressed by image data of one frame period is also referred to as a frame image.

Note that compression and expansion of the image data are not relevant to the essence of the present invention. Therefore, in the following description, presence of compression and expansion of the image data is ignored (i.e., for example, recording the compressed image data is simply referred to as recording the image data). In addition, in the present specification, image data of a certain image may be simply referred to as an image.

The imaging apparatus 1 has a function of varying a reproducing speed that is to say a reproducing rate automatically in accordance with a distance between subjects on the moving image when reproducing a moving image in the reproducing mode (hereinafter, referred to as a reproducing speed varying function). The user can freely set enabling or disabling the reproducing speed varying function. Only if the reproducing speed varying function is enabled, the reproducing speed varying function works. The reproducing mode when the reproducing speed varying function is enabled is particularly referred to as an automatic slow motion play mode.

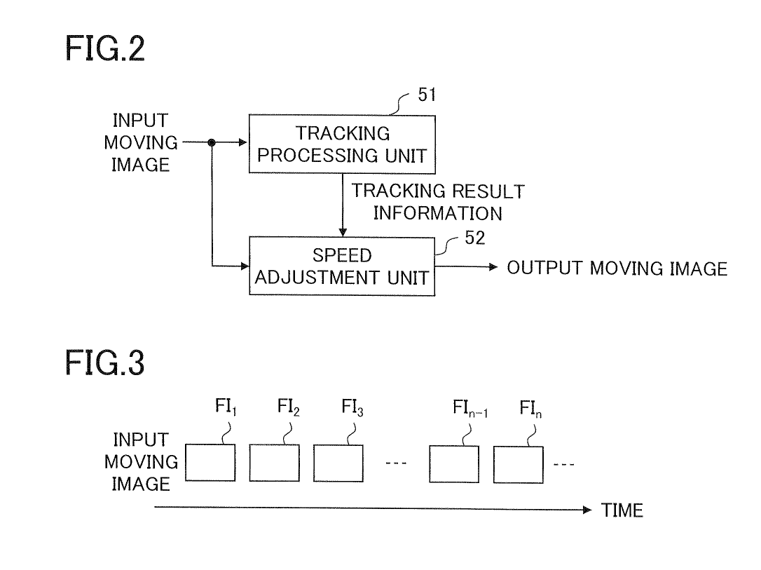

FIG. 2 illustrates a partial block diagram of the imaging apparatus 1 that is related particularly to an operation in the automatic slow motion play mode. A tracking processing unit 51 and a speed adjustment unit 52 in FIG. 2 are disposed in the imaging apparatus 1. For instance, the tracking processing unit 51 and the speed adjustment unit 52 may be disposed in the video signal processing unit 13 or in the display processing unit 20 illustrated in FIG. 1.

The image data of the input moving image is supplied to the tracking processing unit 51 and the speed adjustment unit 52. In the first embodiment, image data of the input moving image is image data of the moving image recorded in the external memory 18, and the image data thereof is obtained by an image sensing operation of the imaging apparatus 1 in the image sensing mode. However, the image data of the input moving image may also be supplied from an apparatus other than the imaging apparatus 1.

The input moving image is constituted of a frame image sequence. The image sequence such as a frame image sequence means a set of still images arranged in a time sequence. Therefore, the frame image sequence is constituted of a plurality of frame images arranged in a time sequence. Each of the frame images is a still image, and each frame image constituting the input moving image is also particularly referred to as an input frame image.

As illustrated in FIG. 3, as symbols representing the input frame images, FI₁, FI₂, FI₃, FIₙ₋₁, FIₙ, and so on are used. Here, n denotes an integer of two or larger. The input frame image FLᵢ₊₁ is a frame image that is taken next after the input frame image Hᵢ (i denotes any natural number). It is supposed that a frame rate of the input moving image is 60 fps (frame per second) over the entire input moving image. In this case, a time difference between the input frame image FIᵢ and the input frame image FIᵢ₊₁, i.e., a difference between image sensing times of the input frame images FIᵢ and the FIᵢ₊₁ is 1/60 seconds with respect to any natural number i. Note that in the present specification, for a simple description, a name corresponding to a symbol may be omitted or abbreviated by referring to the symbol. For instance, an input frame image FIₙ and an image FIₙ mean the same thing.

The tracking processing unit 51 performs a tracking process of tracking a target object on the input moving image based on the image data of the input moving image. If the input moving image is obtained by the image sensing operation of the imaging apparatus 1, the target object is a target subject of the imaging apparatus 1 in the image sensing operation of the input moving image. Hereinafter, the target object to be tracked by the tracking process is referred to as a tracking target.

The user can specify the tracking target. For instance, a so-called touch panel function is provided to the display unit 27. When the input moving image is displayed on a display screen of the display unit 27, the user may touch with his or her finger a display area on the display screen where the target object is displayed, so that the target object is specified as the tracking target. Alternatively, for example, the user may specify the tracking target by a predetermined operation of an operating unit 26. Further, alternatively, a face recognition process may be utilized so that the imaging apparatus 1 set automatically the tracking target. In other words, a face area that is an area including a human face is extracted from the input frame image based on the image data of the input frame image, and the face recognition process checks whether or not the face included in the face area matches a person's face that is enrolled in advance. If the matching is confirmed, the person having the face included in the face area may be set as the tracking target.

After setting the tracking target, the tracking process sequentially detects positions and sizes of the tracking target in the input frame images based on the image data of the input frame image sequence. In reality, an image area in which the image data indicating the tracking target exists is set as the tracking target area in each input frame image, a center position (or a barycenter position) and a size of the tracking target area are detected as a position and a size of the tracking target. The tracking processing unit 51 outputs tracking result information including information that indicates a position and a size of the tracking target in each input frame image.

The tracking process between the first and the second frame images can be performed as follows. Here, the first frame image indicates a frame image in which a position and a size of the tracking target are already detected, and the second frame image indicates a frame image in which a position and a size of the tracking target are to be detected. The second frame image is usually a frame image that is sensed next after the first frame image.

For instance, the tracking processing unit 51 can perform the tracking process based on an image characteristic of the tracking target. The image characteristic includes luminance information and color information. More specifically, for example, a tracking frame that is estimated to have substantially the same size as the tracking target area is set in the second frame image, and similarity between the image characteristic of the image in the tracking frame in the second frame image and the image characteristic of the image in the tracking target area in the first frame image is evaluated while changing a position of the tracking frame sequentially in a search area. Then, it is decided that the center position of the tracking target area in the second frame image exists at the center position of the tracking frame in which the maximum similarity is obtained. The search area with respect to the second frame image is set with reference to a position of the tracking target in the first frame image. For instance, the search area is set as a rectangular area having the center at the position of the tracking target in the first frame image, and a size of the search area (image size) is smaller than the size of the entire image area of the frame image.

Note that it is possible to adopt any other method different from the above-mentioned method as the method for detecting a position and a size of a tracking target on a frame image (e.g., the method described in JP-A-2004-94680 or a method described in JP-A-2009-38777 may be adopted).

The speed adjustment unit 52, which can also referred to as a reproducing speed control unit or a reproducing speed adjustment unit, generates an output moving image from the input moving image based on the tracking result information in the automatic slow motion play mode. Each frame image forming the output moving image is also referred to as an output frame image. When the reproducing speed varying function is enabled, i.e., in the automatic slow motion play mode, the output moving image is reproduced and displayed on the display screen of the display unit 27. Note that if the reproducing speed varying function is disabled, the input moving image is reproduced and displayed as it is at a reproducing speed of 60 fps on the display screen of the display unit 27.

The speed adjustment unit 52 adjusts the reproducing speed of the input moving image based on the tracking result information. The moving image obtained after the adjustment is the output moving image. A method of deciding the reproducing speed based on the tracking result information will be described. In the first embodiment, a case where a plurality of tracking targets is set is supposed. In this case, the tracking processing unit 51 performs a tracking process on each tracking target, and information indicating a position and a size of each tracking target is contained in the tracking result information.

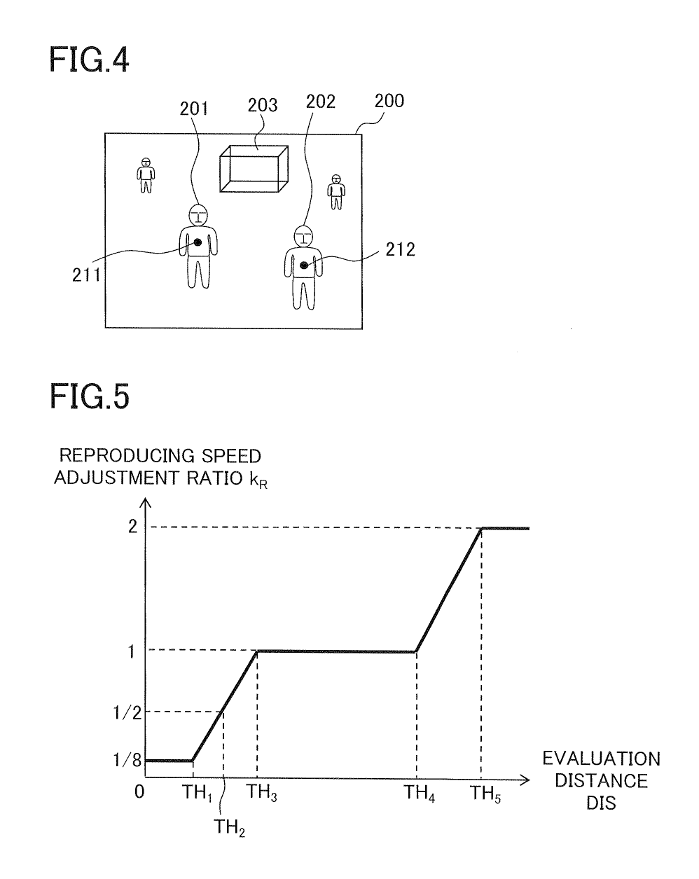

An image 200 illustrated in FIG. 4 indicates one input frame image. In the input frame image 200, a plurality of persons exists (in other words, image data expressing a plurality of persons is contained in the image data of the input frame image 200). The input moving image including the input frame image 200 is obtained by image sensing of a soccer game, and the object denoted by numeral 203 is a goal installed in a soccer stadium. Here, a case is supposed where the user has specified two persons as tracking targets 201 and 202 among the above-mentioned plurality of persons utilizing the touch panel function or the like. When the user wants to see the two persons scrambling for a ball in a soccer game in detail, the user can specify the two persons as the tracking targets.

In FIG. 4, the points 211 and 212 respectively indicate a position of the tracking target 201 detected by the tracking processing unit 51 (i.e., the center position or the barycenter position of the tracking target area in which the image data of the tracking target 201 exists) and a position of the tracking target 202 detected by the tracking processing unit 51 (i.e., the center position or the barycenter position of the tracking target area in which the image data of the tracking target 202 exists).

The speed adjustment unit 52 derives a distance between the positions 211 and 212 on the input frame image of each input frame image as an evaluation distance, so as to change the reproducing speed of the input moving image dynamically based on the evaluation distance.

FIG. 5 illustrates an example of a relationship between a reproducing speed adjustment ratio k_{R} that defines an adjustment amount of the reproducing speed and the evaluation distance. The evaluation distance is denoted by symbol DIS. A lookup table or a mathematical expression that expresses the relationship may be given to the speed adjustment unit 52 in advance. A reference reproducing speed REF_{SP} of the input moving image is equal to the frame rate of 60 fps of the input moving image. The reproducing speed adjustment ratio k_{R} expresses an adjustment ratio of the reproducing speed with reference to the reference reproducing speed REF_{SP}. The reproducing speed of the input moving image is expressed by REF_{SP}×k_{R}. Therefore, as a value of k_{R} is smaller, the reproducing speed becomes smaller. As a value of k_{R} becomes larger, the reproducing speed becomes larger.

In the section in which the reproducing speed adjustment ratio k_{R} is one, the reproducing speed of the input moving image is the same as the reference reproducing speed REF_{SP}In other words, if the reproducing speed adjustment ratio k_{R} is one in the section including the input frame images FIₙ₋₁ to FIₙ₊₁, the input frame images FIₙ₋₁ to FIₙ₊₁ are displayed as a part of the output moving image on the display screen of the display unit 27 by using ((3× 1/60)/k_{R})=((3× 1/60)/1)= 1/20 seconds.

If the reproducing speed adjustment ratio k_{R} is a constant value k_{RO} in the section including the input frame images FIₙ₋₁ to FLₙ₊₁, the input frame images FIₙ₋₁ to FIₙ₊₁ are displayed on the display screen of the display unit 27 as a part of the output moving image by using ((3× 1/60)/k_{RO}) seconds. Therefore, for example, if the reproducing speed adjustment ratio k_{R} is ½ in the section including the input frame images FIₙ₋₁ to FIₙ₊₁, the input frame images FIₙ₋₁ to FIₙ₊₁ are displayed on the display screen of the display unit 27 as a part of the output moving image by using (3× 1/60)/k_{R}=(3× 1/60)/(½)= 1/10 seconds.

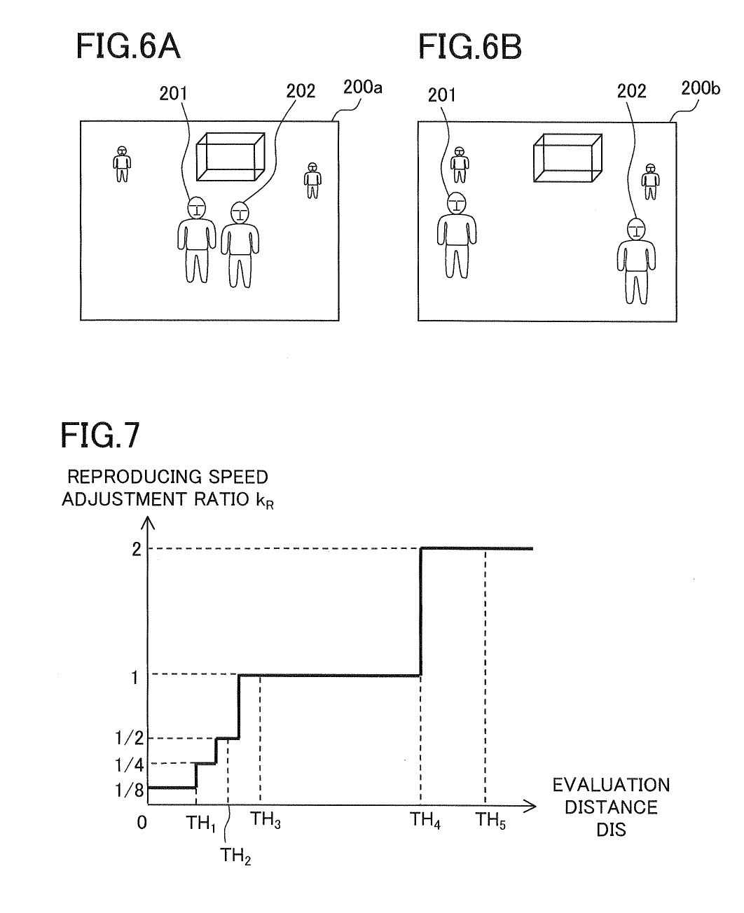

As illustrated in FIG. 5, basically, as the evaluation distance DIS becomes larger, a larger value is set to the reproducing speed adjustment ratio k_{R}. Therefore, in the section where an input frame image sequence having a relatively small evaluation distance DIS including an input frame image 200a illustrated in FIG. 6A is reproduced, a relatively small value is set to the reproducing speed adjustment ratio k_{R} so that the reproducing speed of the input moving image becomes relatively slow. On the contrary, in the section where an input frame image sequence having a relatively large evaluation distance DIS including an input frame image 200b illustrated in FIG. 6B is reproduced, a relatively large value is set to the reproducing speed adjustment ratio k_{R} so that the reproducing speed of the input moving image becomes relatively fast.

In the example illustrated in FIG. 5, if the inequality “DIS<TH₁” holds, “k_{R}=⅛” is set. If the inequality “TH₁≦DIS<TH₃” holds, the reproducing speed adjustment ratio k_{R} is increased from ⅛ to one linearly along with an increase of the evaluation distance DIS from the reference distance TH₁ to the reference distance TH₃. If the inequality “TH₃≦DIS<TH₄” holds, “k_{R}=1” is set. If the inequality “TH₄≦DIS<TH₅” holds, the reproducing speed adjustment ratio k_{R} increased from one to two linearly along with an increase of the evaluation distance DIS from the reference distance TH₄ to the reference distance TH₅. If the inequality “TH₅≦DIS” holds, “k_{R}=2” is set.

Further, in the example illustrated in FIG. 5, the reproducing speed adjustment ratio k_{R} is changed continuously along with the variation of the evaluation distance DIS when the inequality “TH₁≦DIS<TH₃” or “TH₄≦DIS<TH₅” holds. However, as illustrated in FIG. 7, it is possible to change the reproducing speed adjustment ratio k_{R} step by step when the inequality “TH₁≦DIS<TH₃” or “TH₄≦DIS<TH₅” holds. If the relationship between DIS and k_{R} illustrated in FIG. 7 is used, for example, “k_{R}⅛” is set when the inequality “DIS<TH₁” holds, “k_{R}=¼” is set when the inequality “TH₁≦DIS<TH₂−Δ” holds, “k_{R}=½” is set when the inequality “TH₂−Δ≦DIS<TH₂+Δ” holds, “k_{R}=1” is set when the inequality “TH₂+Δ≦DIS<TH₄” holds, and “k_{R}=2” is set when the inequality “TH₄≦DIS” holds (here, Δ>0).

TH₁ to TH₅ denote reference distances that satisfy the inequality “0<TH₁<TH₂<TH₃<TH₄<TH₅” and are set in advance based on a diagonal length of the input frame image that is a rectangular image. If the diagonal length is 100, TH₅≦100 holds, and TH₁=10, TH₂=25, TH₃=30 and TH₄=80 are set, for example.

A relationship between the input moving image and the output moving image will be described with reference to a specific example. It is supposed that the tracking targets 201 and 202 are set before the input frame image FIₙ₋₁ is displayed on the display screen of the display unit 27. The tracking processing unit 51 generates tracking result information for each input frame image after the input frame image FIₙ₋₁, and based on the tracking result information the speed adjustment unit 52 calculates the evaluation distance DIS of each input frame image after the input frame image FIₙ₋₁.

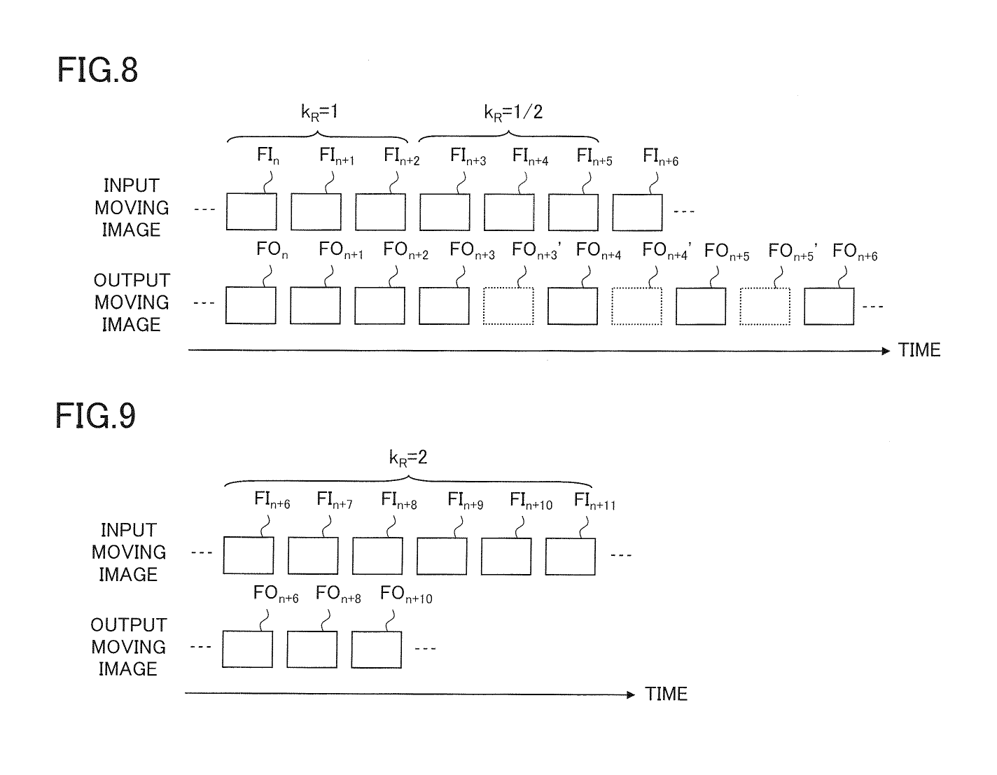

Then, it is supposed that the inequality “TH₃≦DIS<TH₄” holds for the evaluation distance DIS determined with respect to the input frame image FIₙ to FIₙ₊₂, and as illustrated in FIG. 8, one is set to the reproducing speed adjustment ratio k_{R} with respect to the input frame image FIₙ to FIₙ₊₂. In this case, the speed adjustment unit 52 outputs three output frame images FOₙ to FOₙ₊₂ based on three input frame image FIₙ to FIₙ₊₂. The output frame images FOₙ to FOₙ₊₂ are displayed on the display screen of the display unit 27 as a part of the output moving image by using ((3× 1/60)/k_{R})=((3' 1/60)/1)= 1/20 seconds. The output frame images FOₙ to FOₙ₊₂ are the same as the input frame image FIₙ to FIₙ₋₂, respectively.

In addition, it is supposed that the evaluation distance DIS determined with respect to the input frame images FIₙ₊₃ to FIₙ₊₅ is the same or substantially the same as the reference distance TH₂. Then, as illustrated in FIG. 8, the speed adjustment unit 52 sets ½ to the reproducing speed adjustment ratio k_{R} with respect to the input frame images FIₙ₊₃ to FIₙ₊₅ and outputs six output frame images FOₙ₊₃ to FOₙ₊₅ and FOₙ₊₃′ to FOₙ₊₅′ based on three input frame images FIₙ₊₃ to FIₙ₊₅. The output frame images FOₙ₊₃ to FOₙ+₅ are the same as the input frame images FIₙ₊₃ to FIₙ₊₅, respectively. The output frame image FOₙ₊₃′ is inserted between the output frame images FOₙ₊₃ and FOₙ₊₄, and the output frame image FOₙ₊₄′ is inserted between the output frame images FOₙ₊₄ and FOₙ₊₅. The output frame image FOₙ₊₅′ is inserted between the output frame image FOₙ₊₅ and the output frame image FOₙ₊₆ that is the same as the input frame image FIₙ₊₆.

It is possible to generate the output frame image FOₙ₊₃′ that is the same as the input frame image FIₙ₊₃, or it is possible to generate the output frame image FOₙ₊₃′ by interpolation from the input frame images FIₙ₊₃ and FIₙ₊₄ (the same is true for the output frame images FOₙ₊₄′ and FOₙ₊₅′).

The output frame image sequence output from the speed adjustment unit 52 is displayed as the output moving image at a constant frame rate of 60 fps on the display unit 27. In other words, nine output frame images FOₙ, FOₙ₊₁, FOₙ₊₂, FOₙ₊₃, FOₙ₊₃′, FOₙ₊₄, FOₙ₊₄′, FOₙ₊₅ and FOₙ₊₅′ are displayed on the display screen of the display unit 27 as a part of the output moving image by using (9× 1/60) seconds. As a result, the input frame image sequence FIₙ₊₃ to FIₙ₊₅ for which ½ is set to k_{R} is reproduced by slow motion play at a reproducing speed of ½ times the reference reproducing speed REF_{SP}.

When the moving image is reproduced, a sound signal associated with the moving image (a sound signal associated with a video signal of the moving image) is also reproduced by the speaker 28. When the input frame images FIₙ to FIₙ₊₂ for which k_{R}=1 is set are reproduced, a sound signal associated with them is also reproduced at a normal speed. However, when the input frame images F1ₙ₊₃ to FIₙ₊₅ for which k_{R}=½ is set are reproduced, a sound signal associated with them is reproduced at a speed of ½ times the normal speed. In other words, a sound signal associated with the image FIₙ₊₃ is reproduced in an elongated manner until the display of the images FOₙ₋₃ and FOₙ₊₃¹ is finished (the same is true for a sound signal associated with the images FIₙ₊₄ and FIₙ₊₅). Alternatively, it is possible to adopt a configuration in which the sound signal associated with the image FIₙ₊₃ is reproduced at the normal speed when the image FOₙ₊₃ is displayed, and the same sound signal (i.e., the sound signal associated with the image FIₙ₊₃) is reproduced again at the normal speed when the image FIₙ₊₃′ is displayed (the same is true for a sound signal associated with the image FIₙ₊₄ and FIₙ₊₅) .

The slow motion play operation in the case where k_{R}=½ is set with respect to the input frame image sequence FIₙ₊₃ to FIₙ₊₅ is described above, but the same is true for the slow motion play operation in the case where k_{R} is not ½. For instance, if k_{R}=¼ is set with respect to the input frame image sequence FIₙ₊₃ to FIₙ₊₅, images FOₙ₊₃′, FOₙ₊₄′ and FOₙ₊₅′ are inserted between images FOₙ₊₃ and FOₙ₊₄, between images FOₙ₊₄ and FOₙ₊₅, and between images FOₙ₊₅ and F)ₙ₊₆, respectively by three each. In other words, the images FOₙ₊₃′, FOₙ₊₄′ and FOₙ₊₅′ are inserted between images FIₙ₊₃ and FIₙ₊₄, between images FIₙ₊₄ and FIₙ₊₅, and between images FIₙ₊₅ and FIₙ₊₆, respectively by three each. As a result, the input frame image sequence FIₙ₊₃ to FIₙ₊₅ for which ¼ is set to k_{R} is reproduced by slow motion play at a reproducing speed of ¼ times the reference reproducing speed REF_{SP}.

In addition, it is supposed that the evaluation distance DIS determined for the input frame images FIₙ₊₆ to FIₙ₊₁₁ is sufficiently large, and that two is set to the reproducing speed adjustment ratio k_{R} with respect to the input frame images F1ₙ₊₆ to FIₙ₊₁₁ as illustrated in FIG. 9. In this case, the speed adjustment unit 52 generates three output frame images FOₙ₊₆, FOₙ₊₈ and FOₙ₊₁₀ by thinning out a part of the six input frame images FIₙ₊₆ to The output frame images FOₙ₊₆, FOₙ₊₈ and FOₙ₊₁₀ are the same as the input frame images FIₙ₊₆, FIₙ₊₈ and FIₙ₊₁₀, respectively. The three output frame images FOₙ₊₆, FOₙ₊₈ and FOₙ₊₁₀ are displayed on the display screen of the display unit 27 as a part of the output moving image by using (3× 1/60) seconds. In other words, the input frame image sequence FIₙ₊₆ to FIₙ₊₁₁ for which two is set to k_{R} is reproduced by fast forward at a reproducing speed of two times the reference reproducing speed REF_{SP}.

According to this embodiment, slow motion play is automatically performed when a plurality of tracking targets noted by the user (audience) approach (e.g., a plurality of noted persons are scrambling for a ball in a soccer game). In other words, the slow motion play desired by the user is automatically performed. There is a method of utilizing a difference between frames or the like so as to decide presence or absence of a movement of an object in the image for automatically performing slow motion play of an image section in which the object has a movement, but in this method a movement of an object that is not noted by the user is also detected so that slow motion play is performed. According to the method of this embodiment, however, such an undesired slow motion play can be avoided.

In addition, an image section in which the evaluation distance DIS becomes large is not estimated to be an image section of an important scene. Considering this, fast forward play is performed when the evaluation distance DIS is appropriately large in the example described above. Thus, time necessary for viewing and hearing the moving image can be shortened. In addition, if the reproducing speed in the slow motion play is always the same, the picture in the slow motion play is apt to be monotonous. In this embodiment, however, the reproducing speed in the slow motion play is changed by two or more steps (if the reference reproducing speed REF_{SP} is taken into account, reproducing speed is changed by three or more steps). Therefore, slow motion play with presence can be realized.

Note that, it is possible not to perform the above-mentioned fast forward play. In other words, for example, if inequality “TH₃≦DIS” holds, k_{R} may always be one even if the evaluation distance DIS increases any further.

In addition, when image data of at least one of the tracking targets 201 and 202 (see FIG. 4) is not included in the input frame image (when the tracking target becomes out of frame), or the tracking process has failed so that a position of the tracking target cannot be detected, the evaluation distance DIS cannot be calculated. If the calculation of the evaluation distance DIS becomes disabled during reproduction of the input moving image, the reproducing speed of the input moving image is set to the reference reproducing speed REF_{SP} after that. However, if the calculation of the evaluation distance DIS becomes enabled again after that, adjustment of the reproducing speed based on the evaluation distance DIS can be started again.

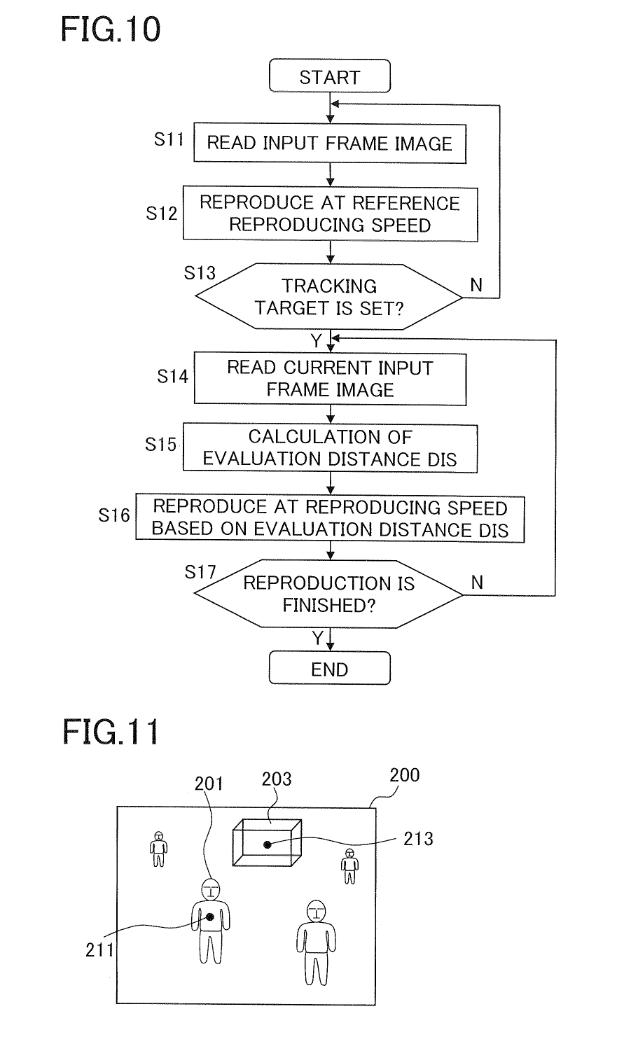

Next, with reference to FIG. 10, an operation flow of the imaging apparatus 1 in the automatic slow motion play mode will be described. FIG. 10 is a flowchart illustrating the operation flow. When an instruction is issued to reproduce a moving image as the input moving image in the automatic slow motion play mode, the input frame images forming the input moving image are read sequentially in the order from earlier frame image from the external memory 18 (Step S11), and the input moving image is reproduced at the reference reproducing speed REF_{SP} until the tracking target is set (Steps S12 and S13). When the tracking target is set by the user's specifying operation or the like (Y in Step S13), the process from Step S14 to S16 is performed. In Step S14 to S16, the current input frame image is read from the external memory 18 (Step S14) so that the evaluation distance DIS is calculated with respect to the current input frame image based on the tracking result information (Step S15), and in addition, the current input frame image is reproduced at a reproducing speed based on the evaluation distance DIS (Step S16). The process from Step S14 to Step S16 is performed repeatedly until the reproduction of the input moving image is finished (Step S17).

### Second Embodiment

A second embodiment of the present invention will be described. The second embodiment is an embodiment as a variation of the first embodiment, and the description described above in the first embodiment is also applied to the second embodiment as long as no contradiction occurs.

In the first embodiment, the distance between a plurality of tracking targets is derived as the evaluation distance DIS. In contrast, in the second embodiment, a distance between a position of a tracking target and a fixed position is derived as the evaluation distance DIS.

The image 200 illustrated in FIG. 11 is an input frame image that is the same as that illustrated in FIG. 4. In the input frame image 200, a plurality of persons exists. It is supposed that the user specifies one of the plurality of persons as the tracking target 201 by using a touch panel function or the like. Further, it is supposed that the user specifies one point in the input frame image 200 using the touch panel function or the like. In FIG. 11, the point denoted by numeral 213 is the specified point, and the position of the specified point in the input frame image 200 is referred to as a fixed position 213. In the example illustrated in FIG. 11, the fixed position 213 is a position where a soccer goal is displayed. As to a soccer game, if the user wants to see in detail the situation where the noted person (tracking target 201) approaches the goal, the user should specify the noted person and the goal by using the touch panel function or the like.

The speed adjustment unit 52 derives a distance between the positions 211 and 213 in the input frame image as the evaluation distance DIS for each input frame image, so as to change dynamically the reproducing speed of the input moving image based on the evaluation distance DIS. If the input frame image changes, the position 211 may also change, but the fixed position 213 does not change. The method of changing dynamically the reproducing speed of the input moving image based on the evaluation distance DIS is the same as that described above in the first embodiment. The operation of generating the output moving image from the input moving image based on the evaluation distance DIS is also the same as that described above in the first embodiment. Further, the operation flow of the imaging apparatus 1 in the automatic slow motion play mode described above with reference to FIG. 10 is also the same as that described above in the first embodiment. However, in the second embodiment, after starting the reproduction of the input moving image, the process from Step S14 to Step S16 is performed after the tracking target and the fixed position are set by the user's specifying operation or the like.

According to this embodiment too, the same effect as the first embodiment can be obtained.

### Third Embodiment

A third embodiment of the present invention will be described. The processes described above based on the record data in the external memory 18 may be performed by electronic equipment different from the imaging apparatus (e.g., the image reproducing apparatus that is not shown) (the imaging apparatus is a type of the electronic equipment).

For instance, the imaging apparatus 1 performs image sensing of the moving image and stores image data of the moving image in the external memory 18. Further, the electronic equipment is equipped with the tracking processing unit 51 and the speed adjustment unit 52 illustrated in FIG. 2 and a display unit and a speaker that are equivalent to the display unit 27 and the speaker 28 illustrated in FIG. 1. Then, the image data of the moving image recorded in the external memory 18 is supplied as image data of the input moving image to the tracking processing unit 51 and the speed adjustment unit 52 in the electronic equipment. In the electronic equipment, the display unit reproduces and displays the output moving image from the speed adjustment unit 52 at a constant frame rate of 60 fps. In this way, reproduction of the input moving image after the reproducing speed adjustment is performed on the display unit of the electronic equipment, and the sound signal associated with the input moving image is also reproduced by the speaker of the electronic equipment.

### Fourth Embodiment

A fourth embodiment of the present invention will be described. The descriptions described in the first or the second embodiment is applied also to the fourth embodiment if no contradiction arises. In the fourth embodiment, a characteristic operation of the imaging apparatus 1 in the image sensing mode will be described.

The imaging apparatus 1 has a function of automatically changing the frame rate of the moving image to be recorded in accordance with a distance between subjects in the moving image when the moving image is recorded in the image sensing mode (hereinafter, referred to as a recording rate varying function). The user can freely set the recording rate varying function to be enabled or disabled. The recording rate varying function works only if the recording rate varying function is enabled. The image sensing mode in the state where the recording rate varying function is enabled is particularly referred to as an automatic slow motion recording mode. The following description in the fourth embodiment is a description of the operation of the imaging apparatus 1 in the automatic slow motion recording mode unless otherwise described.

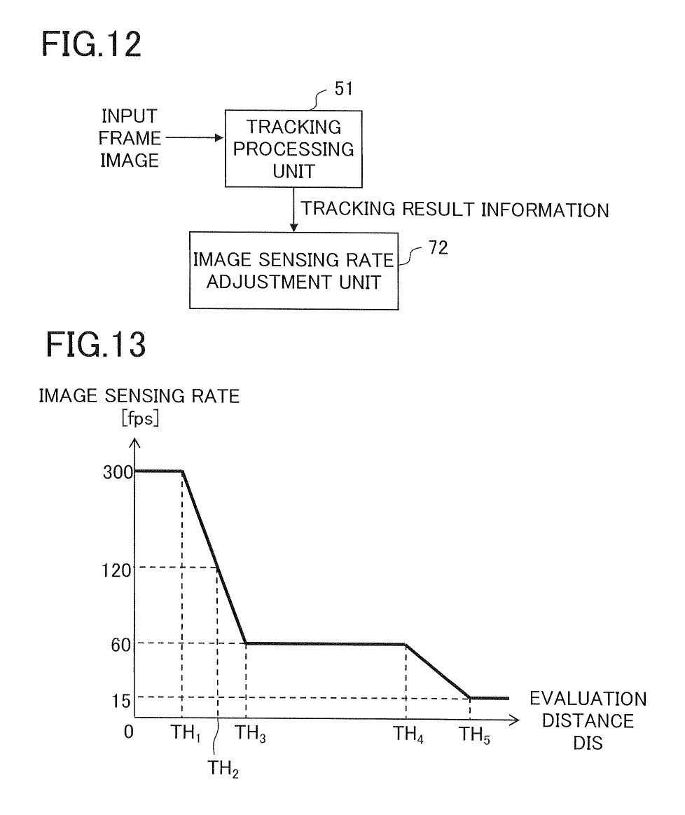

FIG. 12 illustrates a block diagram of a part of the imaging apparatus 1 related particularly to an operation in the automatic slow motion recording mode. The tracking processing unit 51 and an image sensing rate adjustment unit (frame rate control unit) 72 illustrated in FIG. 12 are disposed in the imaging apparatus 1. The tracking processing unit 51 illustrated in FIG. 12 is the same as that illustrated in FIG. 2. The image sensing rate adjustment unit 72 is realized by the CPU 23 and/or TG 22 illustrated in FIG. 1, for example.

The image data of individual frame images obtained by image sensing operation of the image sensing unit 11 are sequentially sent to the tracking processing unit 51 as image data of the input frame images. The image data of the input frame images in this embodiment and a fifth embodiment that will be described later are different from those in the first to third embodiments and indicate image data of the frame images output from the AFE 12 in the automatic slow motion recording mode. In the first to third embodiments, the frame rate of the input frame image sequence is fixed to 60 fps. However, in this embodiment, the frame rate of the input frame image sequence is changed appropriately (details will be described later).

The tracking processing unit 51 performs the tracking process described above in the first embodiment on the given input frame image sequence. In other words, based on the image data of the given input frame image sequence, the tracking of the tracking target on the input frame image sequence is performed on the input frame image sequence. As a result, a position and a size of the tracking target in each input frame image are sequentially detected, so as to output tracking result information containing information indicating a position and a size of the tracking target in each input frame image.

A method of setting the tracking target is as described above in the first embodiment. In the image sensing mode, the input frame images obtained sequentially by image sensing are displayed as the moving image on the display unit 27. The user utilizes the touch panel function and can set the target object as a tracking target by touching with a finger a display area in which the target object to be called a target subject is displayed.

The image sensor 33 of the imaging apparatus 1 can change the frame rate for imaging (hereinafter, referred to as an image sensing rate) in a seamless manner. The image sensing rate adjustment unit 72 illustrated in FIG. 12 dynamically changes the image sensing rate based on the tracking result information in the automatic slow motion recording mode. The change of the image sensing rate is realized by changing a drive mode of the image sensor 33 and a period of a drive pulse supplied from the TG 22 to the image sensor 33. Note that it is supposed that the image sensing rate is always 60 fps when the recording rate varying function is disabled.

Supposing that the user specifies two tracking targets with the touch panel function or the like when the input frame image 200 illustrated in FIG. 4 is displayed, and that the two tracking targets are the tracking targets 201 and 202, a method of changing the image sensing rate by the image sensing rate adjustment unit 72 will be described.

The image sensing rate adjustment unit 72 derives a distance between the positions 211 and 212 on the input frame image as the evaluation distance DIS for each input frame image and changes the image sensing rate dynamically based on the evaluation distance DIS.

FIG. 13 illustrates an example of a relationship between the image sensing rate and the evaluation distance DIS. A lookup table or a mathematical expression expressing the relationship may be given to the image sensing rate adjustment unit 72 in advance. As illustrated in FIG. 13, basically, as the evaluation distance DIS increases, the image sensing rate decreases.

In the example illustrated in FIG. 13, when the inequality “DIS<TH₁” holds, the image sensing rate is set to 300 fps. When the inequality “TH₁≦DIS<TH₃” holds, as the evaluation distance DIS increases from the reference distance TH₁ to the reference distance TH₃, the image sensing rate is decreased from 300 fps to 60 fps linearly. When the inequality “TH₃≦DIS<TH₄” holds, the image sensing rate is set to 60 fps. When the inequality “TH₄≦DIS<TH₅” holds, as the evaluation distance DIS increases from the reference distance TH₄ to the reference distance TH₅, the image sensing rate is decreased linearly from 60 fps to 15 fps. If the inequality “TH₅≦DIS” holds, the image sensing rate is set to 15 fps. In addition, if the evaluation distance DIS is the same or substantially the same as the reference distance TH₂, the image sensing rate is set to 120 fps.

If the image sensing rate can be changed continuously, the above-mentioned adjustment of the image sensing rate can be performed. Usually, however, the image sensing rate can only be changed step by step in many cases. Therefore, as the relationship illustrated in FIG. 5 is changed to the relationship illustrated in FIG. 7, the image sensing rate may be changed not continuously but by step by step in the case where the inequality “TH₁≦DIS<TH₃” or “TH₄≦DIS<TH₅” holds.

More specific operation example will be described. It is supposed that the tracking targets 201 and 202 are set before image sensing of the input frame image Fₙ. For instance, if the inequality “TH₃≦DIS<TH₄” holds with respect to the evaluation distance DIS determined for the input frame images FIₙ to FIₙ₋₂, the image sensing rate for the image sensing section of the input frame images FIₙ to FIₙ₊₂ is set to 60 fps. If the evaluation distance DIS determined for the input frame images FIₙ to FIₙ₊₂ is the same or substantially the same as the reference distance TH₂, the image sensing rate with respect to the image sensing section for the input frame images FIₙ to FIₙ₊₂ is set to 120 fps. If the evaluation distance DIS determined for the input frame images FIₙ to FIₙ₊₂ is the same or substantially the same as the reference distance TH₁, the image sensing rate with respect to the image sensing section of the input frame images FIₙ to FIₙ₊₂ is set to 300 fps. If the evaluation distance DIS determined for the input frame images FIₙ to FIₙ₊₂ is the same or substantially the same as the reference distance TH₅, the image sensing rate with respect to the image sensing section of the input frame images FIₙ to FIₙ₊₂ is set to 15 fps.

The change of the image sensing rate is performed as quickly as possible. In other words, for example, if the inequality “TH₃≦DIS<TH₄” is satisfied with respect to the evaluation distance DIS determined for the input frame images FLₙ to FIₙ₊₂, and if the evaluation distance DIS determined for the input frame images FIₙ₊₃ to FIₙ₊₆ is the same or substantially the same as the reference distance TH₂, the image sensing rate is changed instantaneously if possible, so that the image sensing rate for the image sensing section of the input frame images FIₙ₊₃ to FIₙ₊₆ is set to 120 fps. However, depending on processing time of the tracking process or the like, an image sensing interval between the images FIₙ₊₃ and FLₙ₊₄ and/or an image sensing interval between the images FIₙ₊₄ and FIₙ₊₅ may be larger than 1/120 seconds.

The image data of the input frame image sequence obtained as described above is recorded as image data of the input moving image in the external memory 18. In the reproducing mode, the imaging apparatus 1 reproduces the input moving image read out from the external memory 18 at a constant frame rate of 60 fps by using the display unit 27. Alternatively, it is possible to supply the input moving image recorded in the external memory 18 to other electronic equipment different from the imaging apparatus 1 (e.g., an image reproducing apparatus that is not shown), so that the electronic equipment reproduces the input moving image at a constant frame rate of 60 fps.

A part that is recorded in a state with a high image sensing rate because of a small evaluation distance DIS is reproduced in slow motion because of a large number of recording frames per unit time. On the contrary, a part that is recorded in a state with a low image sensing rate because of a large evaluation distance DIS is reproduced in fast forward because of a small number of recording frames per unit time. As a result, the same effect as the first embodiment can be obtained. In addition, the image sensing is performed actually at high image sensing rate (e.g., 120 fps) when the evaluation distance DIS is small so as to record the image. Therefore, the slow motion play can be performed with high image quality compared with the first to the third embodiments. On the other hand, record data quantity becomes large. In addition, when a part that is sensed at high image sensing rate (e.g., 120 fps) is reproduced by normal play, a thinning out process is necessary.

Note that it is possible not to decrease the image sensing rate when the evaluation distance DIS is large. In other words, for example, if the inequality “TH₃≦DIS” holds, the image sensing rate may always be set to 60 fps even if the evaluation distance DIS becomes so large. In addition, if calculation of the evaluation distance DIS is disabled during image sensing and recording of the input moving image, the image sensing rate of the input moving image should be set to 60 fps after that. However, if the calculation of the evaluation distance DIS is enabled again after that, adjustment of the image sensing rate based on the evaluation distance DIS can be started again.

In addition, as the first embodiment can be modified to be the second embodiment, a distance between a position of the tracking target and the fixed position may be derived as the evaluation distance DIS in this embodiment. In other words, for example, when the input frame image 200 that forms the input moving image is displayed during image sensing of the input moving image (see FIG. 11), the user may specify the tracking target 201 and the fixed position 203 by using the touch panel function or the like. In this case, the image sensing rate adjustment unit 72 derives a distance between the positions 211 and 213 on the input frame image with respect to each input frame image obtained after the input frame image 200 as the evaluation distance DIS, so as to change the image sensing rate of the input frame image sequence obtained after the input frame image 200 dynamically based on the evaluation distance DIS. If the input frame image is different, the position 211 may also change, but the fixed position 213 does not change. The method of changing the image sensing rate dynamically based on the evaluation distance DIS is the same as that described above.

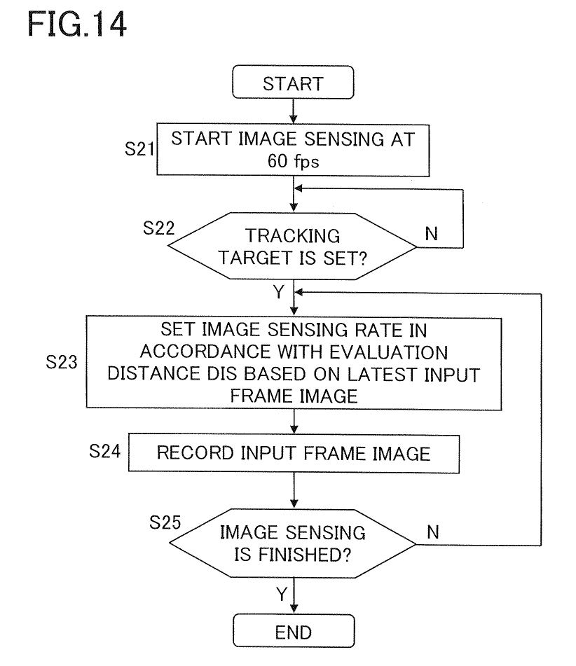

With reference to FIG. 14, an operation flow of the imaging apparatus 1 in the automatic slow motion recording mode will be described. FIG. 14 is a flowchart illustrating this operation flow. In the automatic slow motion recording mode, image sensing of the input moving image is started first at the image sensing rate of 60 fps (Step S21), and the image sensing rate is maintained to be 60 fps until a plurality of tracking targets are set or until a tracking target and a fixed position are set (Step S22). After the time point when the record button 26a is pressed down for the first time, image data of the input frame images are sequentially recorded in the external memory 18. When a plurality of tracking targets are set or a tracking target and a fixed position are set by the user's specifying operation or the like (Y in Step S22), the process of Step S23 and S24 is performed. In Step S23 and S24, the evaluation distance DIS is calculated from the latest input frame image so that the image sensing rate is set in accordance with the latest evaluation distance DIS, and in addition, image data of the latest input frame image are recorded sequentially in the external memory 18. The process of Steps S23 and S24 is performed repeatedly until image sensing of the input moving image is finished (e.g., until the record button 26a is pressed down for a second time) (Step S25).

### Fifth Embodiment

A fifth embodiment of the present invention will be described. The fifth embodiment is an embodiment as a variation of the fourth embodiment, and the description described above in the fourth embodiment is also applied to the fifth embodiment as long as no contradiction arises. In addition, the descriptions described above in the first to third embodiments are also applied to the fifth embodiment as long as no contradiction arises.

In the fifth embodiment, in the automatic slow motion recording mode, the image sensing rate is fixed to 60 fps for obtaining image data of the input moving image, and the image data of the input moving image is supplied to the tracking processing unit 51 and the speed adjustment unit 52 illustrated in FIG. 2, so as to record the image data of the output moving image obtained from the speed adjustment unit 52 in the external memory 18. The method of generating the output moving image from the input moving image is as described in the first or the second embodiment. Then, in the reproducing mode, the imaging apparatus 1 uses the display unit 27 for reproducing the output moving image read out from the external memory 18 at a constant frame rate of 60 fps. Alternatively, the output moving image recorded in the external memory 18 is supplied to other electronic equipment different from the imaging apparatus 1 (e.g., an image reproducing apparatus that is not shown), so that the electronic equipment reproduces the output moving image at a constant frame rate of 60 fps.

According to the fifth embodiment too, similarly to the fourth embodiment, the number of frame images to be recorded per unit time is adjusted in accordance with the evaluation distance DIS. In other words, the frame rate of the moving image recorded by the speed adjustment unit 52 illustrated in FIG. 2 that is also referred to as a recording frame rate control unit or a frame rate control unit is adjusted in accordance with the evaluation distance DIS. Therefore, the same effect is obtained by the fifth embodiment as the fourth embodiment.

### Sixth Embodiment

A sixth embodiment of the present invention will be described. The first and the second embodiment have described the reproducing speed varying function of controlling the reproducing speed of the input moving image dynamically based on the evaluation distance DIS. As described above in the first embodiment, the reproducing mode in the state where the reproducing speed varying function is enabled is particularly referred to as an automatic slow motion play mode. The sixth embodiment will describe another method of realizing the reproducing speed varying function of the imaging apparatus 1 illustrated in FIG. 1. The descriptions described above in the individual embodiments are applied also to the sixth embodiment as long as no contradiction arises.

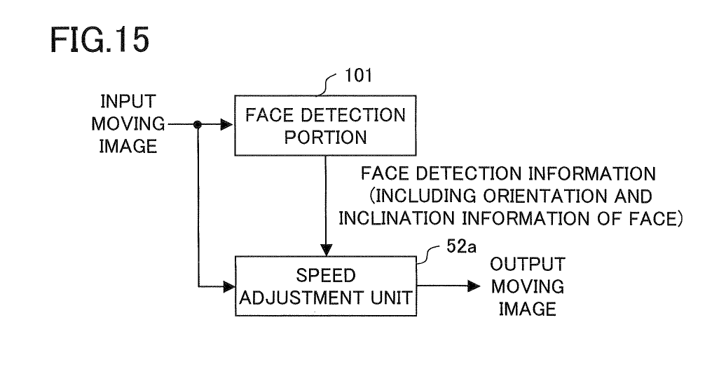

FIG. 15 is a partial block diagram of the imaging apparatus 1 related particularly to an operation in the automatic slow motion play mode according to the sixth embodiment. A face detection portion 101 and a speed adjustment unit 52a illustrated in FIG. 15 may be disposed in the video signal processing unit 13 or the display processing unit 20 illustrated in FIG. 1, for example.

Image data of the input moving image is supplied to the face detection portion 101 and the speed adjustment unit 52a. In the sixth embodiment, the image data of the input moving image is image data of a moving image recorded in the external memory 18, and the image data is obtained by the image sensing operation of the imaging apparatus 1 in the image sensing mode. However, the image data of the input moving image may be supplied from a device other than the imaging apparatus 1. Also in the sixth embodiment and other embodiments described later, similarly to the first embodiment, FI₁, FI₂, FI₃, FIₙ₋₁, FIₙ, and so on are used as symbols denoting input frame images forming the input moving image (see FIG. 3). In addition, in the sixth embodiment, similarly to the first embodiment, it is supposed that a frame rate of the input moving image is 60 fps (frame per second) over the entire input moving image. The following description in the sixth embodiment is about an operation of the imaging apparatus 1 in the automatic slow motion play mode, unless otherwise described.

The face detection portion 101 performs a face detection process with respect to the input frame image based on the input frame image, so as to generate face detection information indicating a result of the face detection process. The face detection portion 101 can perform the face detection process for each of the input frame images. In the face detection process, a person's face is detected from the input frame image based on image data of the input frame image, so that a face area including the detected face is extracted. There are many methods known for detection of a face included in an image, and the face detection portion 101 can adopt any of the methods. For instance, an image portion having high similarity with a reference face image that is enrolled in advance is extracted as a face area from the input frame image, so that a face in the input frame image can be detected.

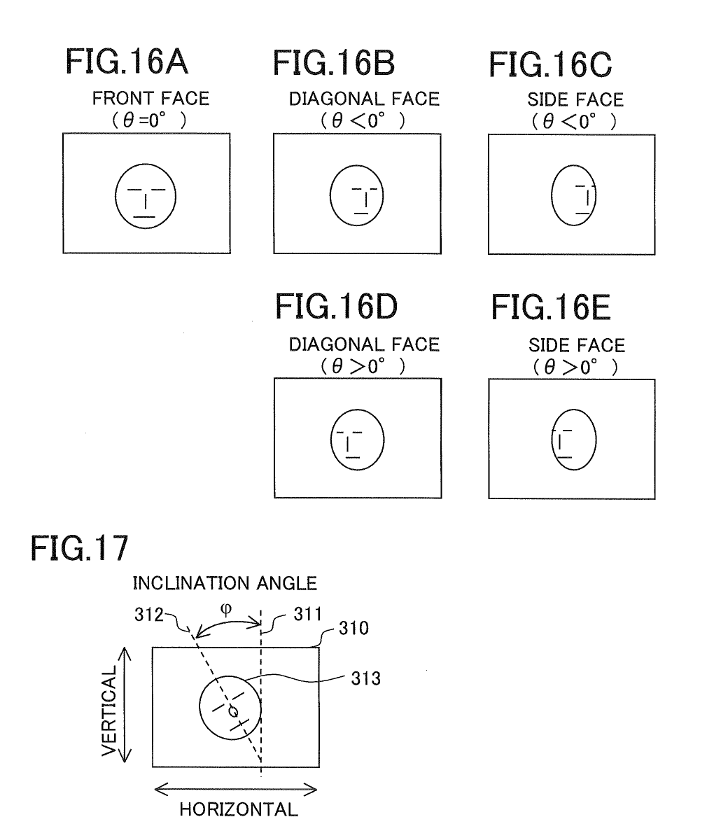

In addition, the face detection portion 101 also detects an orientation of a face in the input frame image in the face detection process. In other words, for example, the face detection portion 101 can detect by distinguishing in a plurality of steps, i.e., can distinguish the face detected from the input frame image whether it is a front face (face viewed from the front) as illustrated in FIG. 16A, or a diagonal face (face viewed from a diagonal direction) as illustrated in FIG. 16B or 16D, or a side face (face viewed from a side) as illustrated in FIG. 16C or 16E. There are various methods proposed for detecting an orientation of a face, and the face detection portion 101 can adopt any of the methods. For instance, the face detection portion 101 can adopt a method described in JP-A-10-307923 in which parts of face such as eyes, a nose and a mouth are found sequentially from the input frame image so as to detect a position of the face in the input frame image, and an orientation of the face is detected based on projection data of the parts of face. Alternatively, for example, a method described in JP-A-2006-72770 may be adopted.

An angle indicating an orientation of a face is denoted by symbol θ, and the angle is referred to as an orientation angle. An orientation angle θ of the front face is 0 degrees, and an orientation angle θ of the side face is 90 degrees or −90 degrees. An orientation angle θ of the diagonal face satisfies “0 degrees<θ<90 degrees” or “−90 degrees<θ<0 degrees”. If a face that faces straight to the front of the imaging apparatus 1 is expressed in the input frame image, the orientation angle θ of the face is 0 degrees. Starting from the state where the face faces straight to the front of the imaging apparatus 1, as the face turns gradually toward either the left or the right direction about an axis of the neck, an absolute value of the orientation angle θ of the face increases gradually toward 90 degrees in the turning process. Here, it is supposed as follows. If the face in the input frame image faces the right direction in the input frame image (see FIGS. 16B and 16C), the orientation angle θ of the face is supposed to be negative. If the face in the input frame image faces the left direction in the input frame image (see FIGS. 16D and 16E), the orientation angle θ of the face is supposed to be positive.

Further, the face detection portion 101 also detects inclination of the face in the input frame image in the face detection process. Here, the inclination of the face means, as illustrated in FIG. 17, inclination of the face 313 with respect to the vertical direction of the input frame image 310. For instance, it is inclination of a straight line 312 connecting the center of mouth and the center of the forehead on the face 313 with respect to a straight line 311 that is parallel to the vertical direction of the input frame image 310. For instance, the input frame image is turned, and the above-mentioned similarity evaluation is performed with respect to the turned image so that the inclined face can be detected. In addition, inclination of the face can be detected.

An angle indicating the inclination of the face is denoted by symbol φ, and the angle is referred to as an inclination angle. In the input frame image 310 illustrated in FIG. 17, the inclination angle φ is an angle formed between the straight line 311 and the straight line 312. As illustrated in FIG. 17, if a straight line obtained by turning the straight line 311 in the counterclockwise direction by an angle smaller than 90 degrees in the input frame image 310 is the straight line 312, the inclination angle φ is negative. Though different from the state illustrated in FIG. 17, if a straight line obtained by turning the straight line 311 in the clockwise direction by an angle smaller than 90 degrees in the input frame image 310 is the straight line 312, the inclination angle φ is positive.

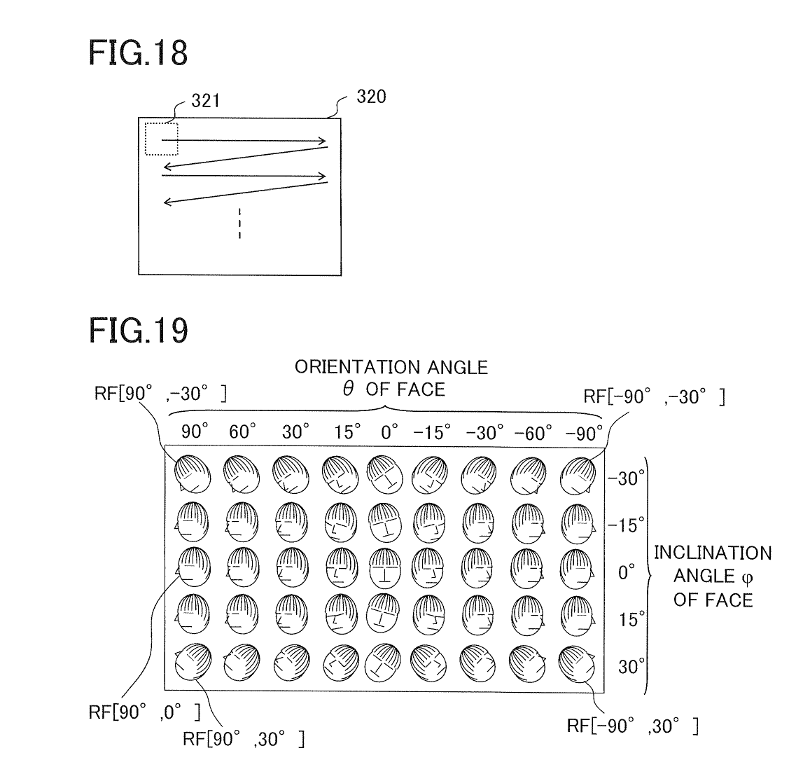

With reference to FIGS. 18 and 19, an example of the face detection process that can be performed by the face detection portion 101 will be described. Further, for convenience sake, the detection of the orientation angle θ of the face is referred to as orientation detection, and the detection of the inclination angle φ of the face is referred to as inclination detection. In FIG. 18, numeral 320 denotes any one of input frame images. A plurality of faces illustrated in FIG. 19 indicates a plurality of reference face images RF[θₒ, φₒ] enrolled in advance in the face detection portion 101. Symbol θₒ denotes an orientation angle of the reference face image RF[θₒ, φₒ], and φₒ denotes an inclination angle of the reference face image RF[θₒ, φₒ]. The reference face images RF[θₒ, φₒ] when the orientation angle θ is −90 degrees, −60 degrees, −30 degrees, −15 degrees, 0 degrees, 15 degrees, 30 degrees, 60 degrees and 90 degrees are set respectively, and the reference face images RF[θₒ, φₒ] when the inclination angle φ is −30 degrees, −15 degrees, 0 degrees, 15 degrees and 30 degrees are set respectively. Therefore, the total number of types of the reference face images RF[θₒ, φₒ] is 45 (=9×5). In FIG. 19, for simple illustration, corresponding symbols (RF[90 degrees, −30 degrees], RF[−90 degrees, −30 degrees], RF[90 degrees, 30 degrees], RF[−90 degrees, 30 degrees] and RF[90 degrees, 0 degrees]) are assigned to only five reference face images.

The face detection portion 101 sets a noted area 321 having a predetermined image size in the input frame image 320. Then, first, the reference face image RF[90 degrees, 0 degrees] that is one of the 45 types of reference face images RF[θₒ, φₒ] is noted, and similarity between the image in the noted area 321 and the reference face image RF[90 degrees, 0 degrees] is decided, thereby it is detected whether or not the noted area 321 includes a face having the orientation angle θ of 90 degrees and the inclination angle φ of 0 degrees. The similarity decision is performed by extracting a characteristic quantity that is effective for distinguishing a face or not. The characteristic quantity includes a horizontal edge, a vertical edge, a right oblique edge, a left oblique edge and the like.

In the input frame image 320, the noted area 321 is shifted by one pixel in the left and right directions or in the upper and lower directions. Then, the image in the noted area 321 after the shifting is compared with the reference face image RF[90 degrees, 0 degrees] so that similarity between the images is decided again for performing similar detection. In this way, the noted area 321 is updated and set so as to be shifted by one pixel, for example, from the upper left corner to the lower right corner of the input frame image 320. The arrow lines in FIG. 18 indicate the process of shifting the noted area 321. In addition, the input frame image 320 is reduced by a constant ratio, and the same orientation detection and inclination detection as described above are performed with respect to the reduced image. By repeating such a process, it is possible to detect a face having any size, the orientation angle θ of 90 degrees and the inclination angle φ of 0 degrees from the input frame image 320.

The process that is performed by noting the reference face image RF[90 degrees, 0 degrees] is also performed in the same manner with respect to the reference face image RF[60 degrees, 0 degrees]. In this way, it is possible to detect a face having any size, the orientation angle θ of 60 degrees and the inclination angle φ of 0 degrees from the input frame image 320. Further, the process that is performed by noting the reference face image RF[90 degrees, 0 degrees] and the RF[60 degrees, 0 degrees] is also performed in the same manner with respect to each of the remaining 43 types of reference face images RF[θₒ, φₒ]. Then, finally, faces having various orientation angles θ and inclination angles φ can be detected from the input frame image 320.

In the example illustrated in FIG. 19, nine steps of orientation angles 0 of the face are detected, and five steps of inclination angles φ of the face are detected. However, the orientation angles θ of the face may be detected by the number of steps other than nine steps, and the inclination angle φ of the face may be detected by the number of steps other than five steps. Based on the similarity between the reference face image RF[90 degrees, 0 degrees] and the image in the noted area 321, and the similarity between the reference face image RF[60 degrees, 0 degrees] and the image in the noted area 321, it is possible to detect the orientation angle θ of the face in the noted area 321 with high resolution in the range satisfying “60 degrees <θ<90 degrees” (e.g., if the former similarity and the latter similarity are substantially the same order, it is possible to detect θ to be 75 degrees). The same is true for detection of the orientation angle θ based on similarity with respect to other reference face images (e.g., RF[60 degrees, 0 degrees] and RF[30 degrees, 0 degrees]). Further, the same is true for detection of the inclination angle φ.

The face detection information generated by the face detection portion 101 contains information indicating presence or absence of a face, and information indicating the orientation angle θ and the inclination angle φ (see FIG. 15). For instance, if the face having the orientation angle θ of 90 degrees and the inclination angle φ of 0 degrees is detected from the input frame image 320 in FIG. 18, information indicating that the orientation angle θ and the inclination angle φ of the detected face are respectively 90 degrees and 0 degrees is contained in the face detection information. It is possible to adopt a structure in which the face detection information further contains information indicating a position and s size of the face in the input frame image. The face detection information is supplied to the speed adjustment unit 52a (see FIG. 15).

The speed adjustment unit 52a generates the output moving image by adjusting the reproducing speed of the input moving image based on the face detection information. The speed adjustment unit 52 (see FIGS. 2 and 5) in the first embodiment adjusts the reproducing speed of the input moving image by using the reproducing speed adjustment ratio k_{R} determined based on the evaluation distance DIS. In contrast, the speed adjustment unit 52a adjusts the reproducing speed of the input moving image by using the reproducing speed adjustment ratio k_{R} determined based on the face detection information.

The speed adjustment unit 52a determines the reproducing speed adjustment ratio k_{R} based on the evaluation angle ANG based on the orientation angle θ and/or the inclination angle φ. The evaluation angle ANG is an angle 101 that is an absolute value of the orientation angle θ, or an angle |φ| that is an absolute value of the inclination angle φ. Alternatively, an angle based on the orientation angle θ and the inclination angle φ may be substituted into the evaluation angle ANG In other words, for example, the evaluation angle ANG may be equal to k₁·|θ|+k₂·|φ|. Here, k₁ and k₂ are predetermined weight coefficients having positive values. If the evaluation angle ANG is the angle |θ|, the detection of inclination of the face can be eliminated from the face detection process. If the evaluation angle ANG is the angle |φ|, the detection of orientation of a face can be eliminated from the face detection process.

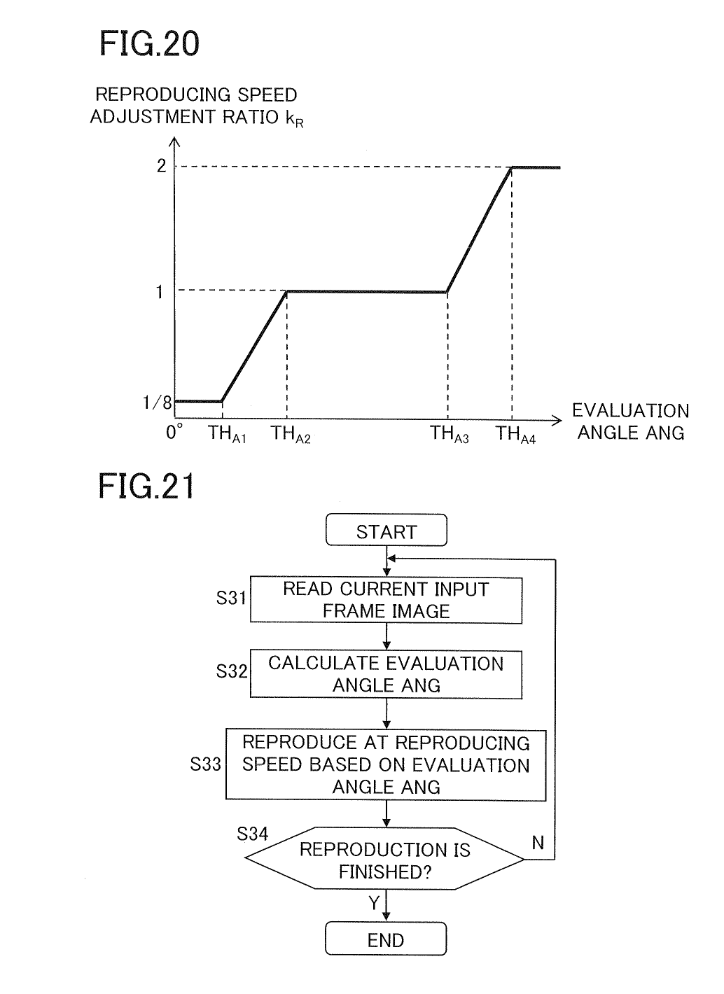

FIG. 20 illustrates an example of a relationship between the reproducing speed adjustment ratio k_{R} and the evaluation angle ANG A lookup table or a mathematical expression expressing the relationship may be given to the speed adjustment unit 52a in advance. As described above, the reproducing speed adjustment ratio k_{R} indicates an adjustment ratio of the reproducing speed with reference to the reference reproducing speed REF_{SP} that agrees with the frame rate of 60 fps of the input moving image, and the reproducing speed of the input moving image is set to REF_{SP}×k_{R}. Therefore, as a value of k_{R} is smaller, the reproducing speed becomes lower. As a value of k_{R} is larger, the reproducing speed becomes higher.

In the example illustrated in FIG. 20, if the inequality “0 degrees≦ANG<TH_{A1}” holds, “k_{R}=⅛” is set. If the inequality “TH_{A1}≦ANG<TH_{A2}” holds, as the evaluation angle ANG increases from the reference angle TH_{A1} to the reference angle TH_{A2}, the reproducing speed adjustment ratio k_{R} is increased linearly from ⅛ to one. If the inequality “TH_{A2}—ANG<TH_{A3}” holds, “k_{R}=1” is set. If the inequality “TH_{A3}≦ANG<TH_{A4}” holds, as the evaluation angle ANG increases from the reference angle TH_{A3} to the reference angle TH_{A4}, the reproducing speed adjustment ratio k_{R} is increased linearly from one to two. If the inequality “TH_{A4}≦ANG” holds, “k_{R}=2” is set.

Note that, in the example illustrated in FIG. 20, if the inequality “TH_{A1}≦ANG<TH_{A2}” or “TH_{A3}≦ANG<TH_{A4}” holds, the reproducing speed adjustment ratio k_{R} is continuously changed in accordance with a change of the evaluation angle ANG However, as the relationship between DIS and k_{R} illustrated in FIG. 5 can be changed to that illustrated in FIG. 7, it is possible to change k_{R} step by step in the case where the inequality “TH_{A1}≦ANG<TH_{A2}” or “TH_{A3}≦ANG<TH_{A4}” holds.

TH_{A1} to TH_{A4} are reference angles satisfying the inequality “0 degrees<TH_{A1}<TH_{A2}<TH_{A3}<TH_{A4}≦90 degrees”, and they can be set in advance. However, TH_{A1}=TH_{A2} can be set, or TH_{A2}=TH_{A3} can be set, or TH_{A3}=TH_{A4} can be set. If ANG=|θ| holds, for example, 15 degrees, 30 degrees, 45 degrees and 90 degrees are substituted into TH_{A1}, TH_{A2}, TH_{A3} and TH_{A4}, respectively. If ANG=|φ| holds, for example, 5 degrees, 10 degrees, 20 degrees and 30 degrees are substituted into TH_{A1}, TH_{A2}, TH_{A3} and TH_{A4}, respectively.

Except for the different method of determining the reproducing speed adjustment ratio k_{R}, the method of generating the output moving image by the speed adjustment unit 52a is the same as that by the speed adjustment unit 52 (see FIGS. 8 and 9). The output moving image output from the speed adjustment unit 52a is displayed on the display unit 27 at a constant frame rate of 60 fps. A method of reproducing the sound signal associated with the input moving image is the same as that described above in the first embodiment.

In the moving image containing human face images, an image section containing a human face image facing the front or substantially the front, or an image section in which the inclination of the face is 0 degrees or is close to 0 degrees is a noted section for the user (audience), which may want to reproduced the section by using relatively long time. Considering this, in this embodiment, if a human face in the input moving image faces the front or substantially the front, or if the inclination of the face in the input moving image is 0 degrees or is close to 0 degrees, the reproducing speed is decreased automatically. In this way, the slow motion play is performed in accordance with a desire of the user (audience).

In addition, an image section containing a human face image facing sideway or an image section in which the inclination of a human face is relatively large is estimated to be not an image section of an important scene. Considering this, in the above-mentioned example, the fast forward play is performed if the evaluation angle ANG is appropriately large. In this way, it is possible to shorten time necessary for playing the moving image. In addition, if the reproducing speed in the slow motion play is always the same, the image in the slow motion play may be felt to be monotonous. Considering this, it is preferable to change the reproducing speed in the slow motion play based on the evaluation angle ANG by two or more steps (it is preferable to change the reproducing speed by three or more steps if the reference reproducing speed REF_{SP} is also taken into account). In this way, slow motion play with presence can be realized.

Note that it is possible to adopt a structure in which the above-mentioned fast forward play is not performed. In other words, for example, if the inequality “TH_{A2}≦ANG” holds, it is possible to set k_{R} to one every time even if the evaluation angle ANG increases to any large value. In addition, the reproducing speed of the input moving image is set to the reference reproducing speed REF_{SP} in a section in which the evaluation angle ANG cannot be determined, such as a section in which a face cannot be detected from the input frame image.

Next, with reference to FIG. 21, an operation flow of the imaging apparatus 1 in the automatic slow motion play mode in the sixth embodiment will be described. FIG. 21 is a flowchart illustrating this operation flow. When reproduction of a moving image as the input moving image in the automatic slow motion play mode is instructed, the input frame images constituting the input moving image are read out from the external memory 18 sequentially in the order from earlier frame image, and the evaluation angles ANG are derived sequentially so that the reproducing speed is adjusted. In other words, the current input frame image is read out from the external memory 18 (Step S31), and the evaluation angle ANG is calculated based on the face detection information with respect to the current input frame image (Step S32). Then, the current input frame image is reproduced at a reproducing speed based on the evaluation angle ANG (Step S33). The process from Step S31 to Step S33 is performed repeatedly until the reproduction of the input moving image is finished (Step S34).

Note that the above-mentioned processes based on the record data in the external memory 18 may be performed by electronic equipment different from the imaging apparatus (e.g., the image reproducing apparatus that is not shown) (the imaging apparatus is a type of the electronic equipment). For instance, the imaging apparatus 1 performs image sensing of the moving image and stores image data of the moving image in the external memory 18. Further, the electronic equipment is equipped with the face detection portion 101 and the speed adjustment unit 52a illustrated in FIG. 15, and a display unit and a speaker that are equivalents to the display unit 27 and the speaker 28 illustrated in FIG. 1. Then, image data of the moving image recorded in the external memory 18 is preferably supplied to the face detection portion 101 and the speed adjustment unit 52a of the electronic equipment as the image data of the input moving image. In the electronic equipment, the display unit reproduces and displays the output moving image from the speed adjustment unit 52a at a constant frame rate of 60 fps. In this way, reproduction of the input moving image after the reproducing speed adjustment is performed on the display unit of the electronic equipment, and the sound signal associated with the input moving image is also reproduced by the speaker of the electronic equipment.

### Seventh Embodiment

A seventh embodiment of the present invention will be described. The above-mentioned fourth embodiment describes the recording rate varying function in which the frame rate of the recorded moving image is controlled dynamically based on the evaluation distance DIS. As described above in the fourth embodiment, the image sensing mode in the state where the recording rate varying function is enabled is particularly referred to as the automatic slow motion recording mode. The seventh embodiment will describe another method of realizing the recording rate varying function of the imaging apparatus 1 illustrated in FIG. 1. The descriptions described above in the individual embodiments are applied also to the seventh embodiment as long as no contradiction arises.

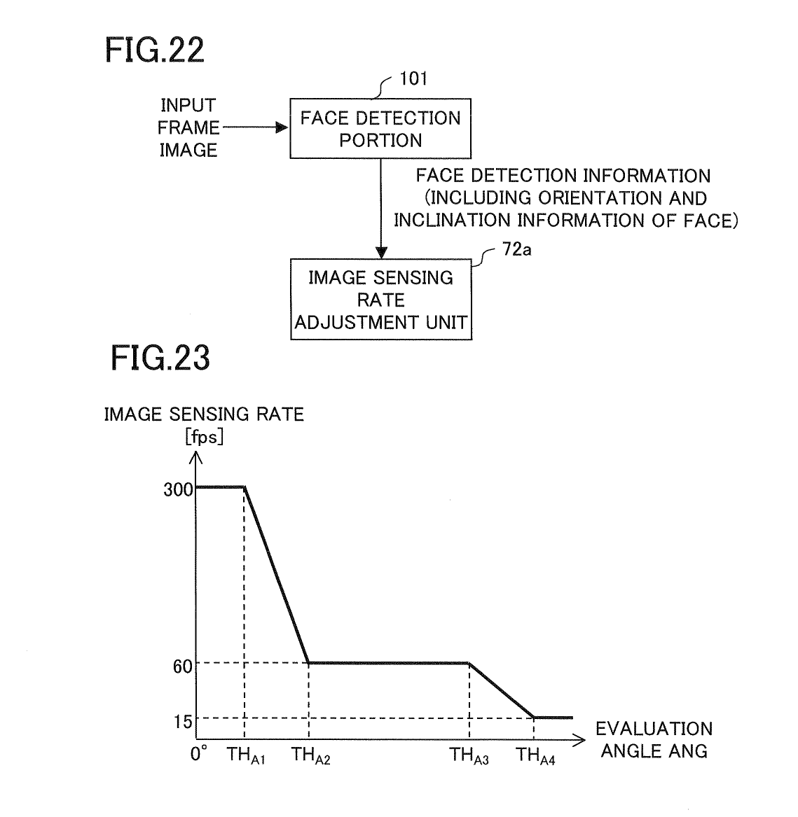

FIG. 22 is a partial block diagram of the imaging apparatus 1 related particularly to an operation in the automatic slow motion recording mode according to the seventh embodiment. A face detection portion 101 illustrated in FIG. 22 is the same as that illustrated in FIG. 15. An image sensing rate adjustment unit 72a is realized by the CPU 23 and/or TG 22 illustrated in FIG. 1, for example. The image data of the input frame image in the seventh embodiment indicates image data of the frame image output from the AFE 12 in the automatic slow motion recording mode similarly to the fourth and the fifth embodiments described above. The following description in the seventh embodiment is a description of an operation of the imaging apparatus 1 in the automatic slow motion recording mode unless otherwise described.

In the automatic slow motion recording mode, image data of the input frame images that are sequentially obtained are supplied to the face detection portion 101. The face detection portion 101 performs the face detection process on the input frame image based on the image data of the input frame image so as to generate face detection information indicating a result of the face detection process. The descriptions of the face detection process and the face detection information are the same as those described in the sixth embodiment.

The image sensing rate adjustment unit 72a changes image sensing rate dynamically based on the face detection information in the automatic slow motion recording mode. More specifically, the evaluation angle ANG is calculated from the face detection information, and the image sensing rate is dynamically changed in accordance with the evaluation angle ANG The evaluation angle ANG can be calculated for each input frame image. The method of calculating the evaluation angle ANG is the same as that described above in the sixth embodiment.

FIG. 23 illustrates an example of a relationship between the image sensing rate and the evaluation angle ANG A lookup table or a mathematical expression expressing the relationship may be given to the image sensing rate adjustment unit 72a in advance. As illustrated in FIG. 23, basically, as the evaluation angle ANG increases, the image sensing rate is decreased.

In the example illustrated in FIG. 23, if the inequality “ANG<TH_{A1}” holds, the image sensing rate is set to 300 fps. If the inequality “TH_{A1}≦ANG<TH_{A2}” holds, as the evaluation angle ANG increases from the reference angle TH_{A1} to the reference angle TH_{A2}, the image sensing rate is decreased linearly from 300 fps to 60 fps. If the inequality “TH_{A2}≦ANG<TH_{A3}” holds, the image sensing rate is set to 60 fps. If the inequality “TH_{A3}≦ANG<TH_{A4}” holds, as the evaluation angle ANG increases from the reference angle TH_{A3} to the reference angle TH_{A4}, the image sensing rate is decreased linearly from 60 fps to 15 fps. If the inequality “TH_{A4}≦ANG” holds, the image sensing rate is set to 15 fps.

If the image sensing rate can be changed continuously, the above-mentioned adjustment of the image sensing rate can be performed. Usually, however, the image sensing rate can only be changed step by step in many cases. Therefore, as the relationship illustrated in FIG. 5 is changed to the relationship illustrated in FIG. 7, the image sensing rate may be changed not continuously but by step by step in the case where the inequality “TH_{A1}≦ANG<TH_{A2}” or “TH_{A3}≦ANG<TH_{A4}” holds.

In the fourth embodiment described above, the image sensing rate is set based on the evaluation distance DIS as quantity of state. In contrast, in the seventh embodiment, the image sensing rate is set based on the evaluation angle ANG as another quantity of state. Except for the point that the quantity of state to be a reference for setting the image sensing rate is different, the function of the image sensing rate adjustment unit 72a is similar to the function of the image sensing rate adjustment unit 72 (see FIG. 12) according to the fourth embodiment. Therefore, for example, the image sensing rate for the image sensing section of the input frame images FIₙ to FIₙ₊₂ is set to 300 fps if the inequality “ANG<TH_{A1}” holds with respect to the evaluation angle ANG determined for the input frame images FIₙ to FIₙ₊₂. If the inequality “TH_{A2}≦ANG<TH_{A3}” holds, it is set to 60 fps. If the inequality “TH_{A4}≦ANG” holds, it is set to 15 fps. As described above in the fourth embodiment, the change of the image sensing rate is performed as quickly as possible.

The image data of the input moving image obtained as described above is recorded in the external memory 18. In the reproducing mode, the imaging apparatus 1 reproduces the input moving image read out from the external memory 18 at a constant frame rate of 60 fps by using the display unit 27. Alternatively, it is possible to supply the input moving image recorded in the external memory 18 to other electronic equipment different from the imaging apparatus 1 (e.g., an image reproducing apparatus that is not shown), so that the electronic equipment reproduces the input moving image at a constant frame rate of 60 fps. When the input moving image is reproduced, the input sound signal recorded in the external memory 18 is also reproduced by the speaker 28.

A part that is recorded in a state with a high image sensing rate because of a small evaluation angle ANG is played in slow motion because of a large number of recording frames per unit time. On the contrary, a part that is recorded in a state with a low image sensing rate because of a large evaluation angle ANG is reproduced in fast forward because of a small number of recording frames per unit time. As a result, the same effect as in the sixth embodiment can be obtained. In addition, the image sensing is performed actually at high image sensing rate (e.g., 300 fps) when the evaluation angle ANG is small so as to record the image. Therefore, the slow motion play can be performed with high image quality compared with the sixth embodiment. On the other hand, record data quantity becomes large. In addition, when a part that is sensed at high image sensing rate (e.g., 300 fps) is reproduced by normal play, a thinning out process is necessary.

Note that it is possible not to decrease the image sensing rate when the evaluation angle ANG is large. In other words, for example, if the inequality “TH_{A2}≦ANG” holds, the image sensing rate may always be set to 60 fps even if the evaluation angle ANG becomes so large. In addition, if calculation of the evaluation angle ANG is disabled during image sensing and recording of the input moving image, the image sensing rate of the input moving image should be set to 60 fps after that. However, if the calculation of the evaluation angle ANG is enabled again after that, adjustment of the image sensing rate based on the evaluation angle ANG can be started again.

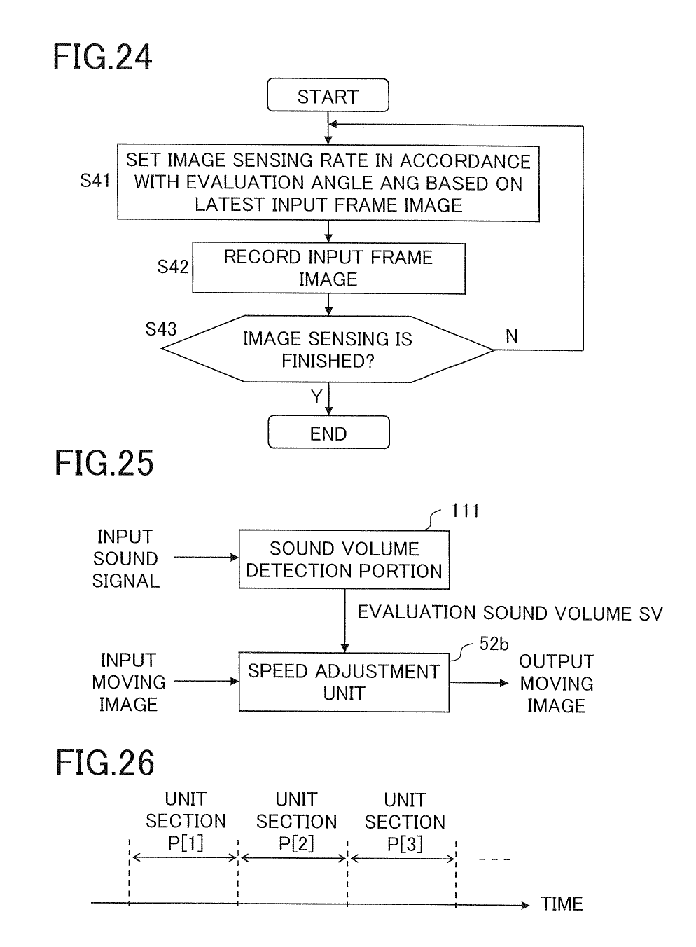

With reference to FIG. 24, an operation flow of the imaging apparatus 1 in the automatic slow motion recording mode according to the seventh embodiment will be described. FIG. 24 is a flowchart illustrating this operation flow. In the automatic slow motion recording mode, image data of the input frame images are sequentially recorded in the external memory 18 after the time point when the record button 26a is pressed down for the first time. In this case, the evaluation angle ANG is calculated from the latest input frame image so that the image sensing rate is set in accordance with the latest evaluation angle ANG (Step S41). In addition, image data of the latest input frame image are recorded sequentially in the external memory 18 (Step S42). The process of Steps S41 and S42 is performed repeatedly until image sensing of the input moving image is finished (e.g., until the record button 26a is pressed down for a second time) (Step S43).

Further, as the fourth embodiment can be modified to be the fifth embodiment, the above-mentioned method in the seventh embodiment can be modified as follows.

Specifically, in the automatic slow motion recording mode, the image sensing rate is fixed to 60 fps for obtaining image data of the input moving image, and the image data of the input moving image is supplied to the face detection portion 101 and the speed adjustment unit 52a illustrated in FIG. 15, so as to record the image data of the output moving image obtained from the speed adjustment unit 52a in the external memory 18. The method of generating the output moving image from the input moving image is as described above in the sixth embodiment. Then, in the reproducing mode, the imaging apparatus 1 uses the display unit 27 for reproducing the output moving image read out from the external memory 18 at a constant frame rate of 60 fps. Alternatively, the output moving image recorded in the external memory 18 is supplied to other electronic equipment different from the imaging apparatus 1 (e.g., an image reproducing apparatus that is not shown), so that the electronic equipment reproduces the output moving image at a constant frame rate of 60 fps. In this way, too, the number of frame images to be recorded per unit time is adjusted in accordance with the evaluation angle ANG That is to say, the frame rate of the moving image to be recorded is adjusted in accordance with the evaluation angle ANG by the speed adjustment unit 52a illustrated in FIG. 15 that is also referred to as a recording frame rate control unit or a frame rate control unit. Thus, the same effect can be obtained as the case where the image sensing rate is adjusted by using the image sensing rate adjustment unit 72a illustrated in FIG. 22.

### Eighth Embodiment

An eighth embodiment of the present invention will be described. In the eighth embodiment, still another method of realizing the reproducing speed varying function of the imaging apparatus 1 illustrated in FIG. 1 will be described. The descriptions described above in the individual embodiments are also applied to the eighth embodiment as long as no contradiction arises.

FIG. 25 is a partial block diagram of the imaging apparatus 1 related particularly to an operation in the automatic slow motion play mode according to the eighth embodiment. A sound volume detection portion 111 illustrated in FIG. 25 can be disposed, for example, in the sound signal processing unit 15 illustrated in FIG. 1. A speed adjustment unit 52b illustrated in FIG. 25 can be disposed, for example, in the video signal processing unit 13 or the display processing unit 20 illustrated in FIG. 1.

The image data of the input moving image is supplied to the speed adjustment unit 52b. In the eighth embodiment, the image data of the input moving image is image data of the moving image recorded in the external memory 18, and the image data is obtained by image sensing operation of the imaging apparatus 1 in the image sensing mode. However, the image data of the input moving image may be supplied from a device other than the imaging apparatus 1. In addition, in the eighth embodiment, similarly to the first embodiment, the frame rate of the input moving image is set to 60 fps (frame per second) over the entire input moving image. The following description in the eighth embodiment is a description of an operation of the imaging apparatus 1 in the automatic slow motion play mode, unless otherwise described.

The sound signal associated with the image data of the input moving image is supplied as the input sound signal to the sound volume detection portion 111. The input sound signal is a sound signal collected by the microphone 14 illustrated in FIG. 1 in the image sensing section of the input moving image and is recorded together with the image data of the input moving image in the external memory 18 in the image sensing mode. In the eighth embodiment, as illustrated in FIG. 26, the entire image sensing section of the input moving image is divided into a plurality of unit sections P[1], P[2], P[3], and so on. A time length of each unit section is L times the frame period ( 1/60 seconds in this embodiment). Here, L denotes a natural number.

The sound volume detection portion 111 detects a magnitude of the input sound signal in the unit section based on the input sound signal in the unit section for each unit section and outputs an evaluation sound volume that is information indicating the detected magnitude. The evaluation sound volume is denoted by symbol SV, and the evaluation sound volume SV with respect to the unit section P[i] is particularly denoted by symbol SV[i] (i denotes an integer). The magnitude of the input sound signal may be a signal level of the input sound signal or may be a power of the input sound signal. If the signal level or the power of the input sound signal increases, the sound volume and the evaluation sound volume SV of the input sound signal increases. If the signal level or the power of the input sound signal decreases, the sound volume and the evaluation sound volume SV of the input sound signal decreases. Note that it is supposed that the lower limit value of the evaluation sound volume SV[i] is zero. In other words, it is supposed that if the signal level or the power of the input sound signal in the unit section P[i] is zero, the evaluation sound volume SV[i] becomes zero.

The magnitude of the input sound signal detected by the sound volume detection portion 111 is an average magnitude of the input sound signal in the unit section. Therefore, for example, the sound volume detection portion 111 calculates an average value of the signal level or the power of the input sound signal in a unit section P[1] based on the input sound signal in the unit section P[1] and outputs the average value as an evaluation sound volume SV[1] with respect to the unit section P[1]. The same is true for other unit sections.

The speed adjustment unit 52b adjusts the reproducing speed of the input moving image based on the evaluation sound volume SV so as to generate the output moving image. In the first embodiment or the sixth embodiment (see FIG. 5 or FIG. 20), the reproducing speed adjustment ratio k_{R} determined based on the evaluation distance DIS or the evaluation angle ANG is used for adjusting the reproducing speed of the input moving image. In contrast, the speed adjustment unit 52b uses the reproducing speed adjustment ratio k_{R} determined based on the evaluation sound volume SV for adjusting the reproducing speed of the input moving image.

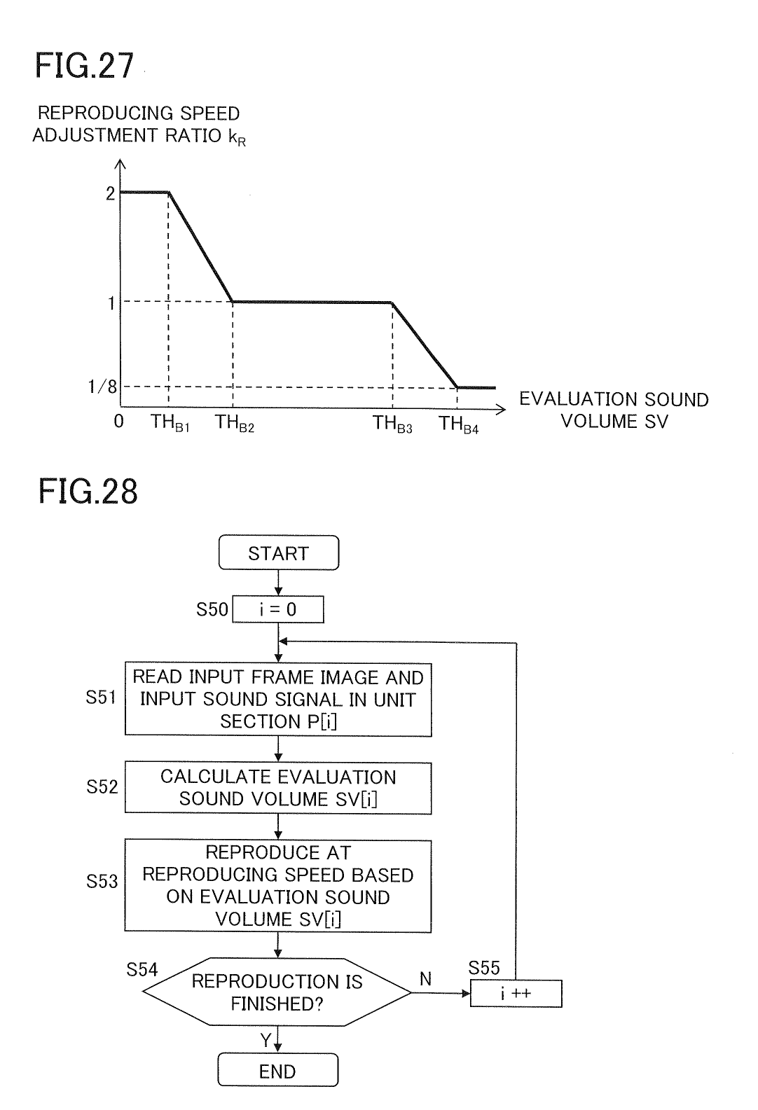

FIG. 27 illustrates an example of a relationship between the reproducing speed adjustment ratio k_{R} and the evaluation sound volume SV. A lookup table or a mathematical expression expressing the relationship may be given to the speed adjustment unit 52b in advance.

In the example illustrated in FIG. 27, if the inequality “0≦SV<TH_{B1}” holds, “k_{R}=2” is set. If the inequality “TH_{B1}≦SV<TH_{B2}” holds, as the evaluation sound volume SV increases from the reference sound volume TH_{B1} to the reference sound volume TH_{B2}, the reproducing speed adjustment ratio k_{R} is decreased linearly from two to one. If the inequality “TH_{B2}≦SV<TH_{B3}” holds, “k_{R}=1” is set. If the inequality “TH_{B3}≦SV<TH_{B4}” holds, as the evaluation sound volume SV increases from the reference sound volume TH_{B3} to the reference sound volume TH_{B4}, the reproducing speed adjustment ratio k_{R} is decreased linearly from one to ⅛. If the inequality “TH_{B4}≦SV” holds, “k_{R}=⅛” is set.

Note that, in the example illustrated in FIG. 27, the reproducing speed adjustment ratio k_{R} is changed continuously with respect to the change of the evaluation sound volume SV in the case where the inequality “TH_{B1}≦SV<TH_{B2}” or “TH_{B3}≦SV<TH_{B4}” holds. However, as the relationship between DIS and k_{R} illustrated in FIG. 5 can be changed to that illustrated in FIG. 7, it is possible to change k_{R} step by step in the case where the inequality “TH_{B1}≦SV<TH_{B2}” or “TH_{B3}≦SV<TH_{B4}” holds.

TH_{B1} to TH_{B4} denote reference sound volumes satisfying the inequality “0<TH_{B1}<TH_{B2}<TH_{B3}<TH_{B4}” and can be set in advance. However, TH_{B1}=TH_{B2} may be set, or TH_{B2}=TH_{B3} may be set, or TH_{B3}=TH_{B4} may be set.

Except for the point that the method of determining the reproducing speed adjustment ratio k_{R} is different, the method for generating the output moving image by the speed adjustment unit 52b is similar to that by the speed adjustment unit 52 (see FIG. 8 and FIG. 9). However, in the eighth embodiment, based on the evaluation sound volume SV[i] based on the input sound signal belonging to the unit section P[i], the reproducing speed of the input frame images in the unit section P[i] is controlled. In other words, the reproducing speed adjustment ratio k_{R} for the unit section P[i] is determined based on the evaluation sound volume SV[i], so that the output frame images belonging to the unit section P[i] are generated from the input frame images belonging to the unit section P[i] based on the reproducing speed adjustment ratio k_{R} with respect to the unit section P[i].

Therefore, for example, in the case where the number of input frame images belonging to each unit section (i.e., the value of L) is four,

if the inequality “0≦SV[i]<TH_{B1}” holds, two output frame images belonging to the unit section P[i] are generated from four input frame images belonging to the unit section P[i],

if the inequality “TH_{B2}≦SV[i]<TH_{B3}” holds, four input frame images belonging to the unit section P[i] are generated as four output frame images belonging to the unit section P[i], and

if the inequality “TH_{B4}≦SV[i]” holds, 32 output frame images belonging to the unit section P[i] are generated from four input frame images belonging to the unit section P[i].

The output moving image output from the speed adjustment unit 52b is displayed on the display unit 27 at the constant frame rate of 60 fps. The method of reproducing the sound signal associated with the input moving image is the same as described above in the first embodiment.

For instance, when a moving image obtained by image sensing of a soccer game is reproduced, an image section in which the magnitude of the sound signal is high is considered to correspond to a section in full swing of the game. Therefore, such the image section has a high probability of being a noted section for the user (audience) and will be desired to be reproduced using relatively long time. Considering this, in this embodiment, if the magnitude of the sound signal is high and it is estimated to be in full swing of the game, the reproducing speed is automatically decreased. In this way, the slow motion play is performed in accordance with desire of the user (audience).

In addition, the image section in which the magnitude of the sound signal is relatively low is estimated not to be an image section of an important scene. Considering this, in the above-mentioned example, the fast forward play is performed if the evaluation sound volume SV is appropriately low. In this way, time necessary for playing the moving image can be shortened. In addition, if the reproducing speed in the slow motion play is always the same, the image in the slow motion play may be apt to be monotonous. Considering this, it is preferable to change the reproducing speed in the slow motion play based on the evaluation sound volume SV by two or more steps (it is preferable to change the reproducing speed by three or more steps if the reference reproducing speed REF_{SP} is also taken into account). In this way, slow motion play with presence can be realized.

Note that, it is possible to adopt a structure in which the above-mentioned fast forward play is not performed. In other words, for example, if the inequality “SV<TH_{B3}” holds, it is possible to set k_{R} to one every time even if the evaluation sound volume SV decreases to any small value.

Next, with reference to FIG. 28, an operation flow of the imaging apparatus 1 in the automatic slow motion play mode in the eighth embodiment will be described. FIG. 28 is a flowchart illustrating this operation flow. When reproduction of a moving image as the input moving image in the automatic slow motion play mode is instructed, the input frame images constituting the input moving image and input sound signal are read out from the external memory 18 sequentially in the order from earlier frame image and earlier sound signal, and the evaluation sound volumes SV are derived sequentially so that the reproducing speed is adjusted.

Specifically, after one is substituted into the variable i in Step S50, the input frame image and the input sound signal in the unit section P[i] is read out from the external memory 18 in Step S51, and the evaluation sound volume SV[i] is calculated from the input sound signal in the unit section P[i] in the next Step S52. Then, in the next Step S53, the input frame image in the unit section P[i] is reproduced at the reproducing speed based on the evaluation sound volume SV[i]. The process from Step S51 to Step S53 is performed repeatedly until the reproduction of the input moving image is finished (Step S54), and the variable i is incremented by one every time when the process from Step S51 to Step S53 is performed once (Step S55).

Note that, above-mentioned processes based on the record data in the external memory 18 may be performed by electronic equipment different from the imaging apparatus (e.g., the image reproducing apparatus that is not shown) (the imaging apparatus is a type of the electronic equipment). For instance, the imaging apparatus 1 performs image sensing of the moving image and stores image data of the moving image and the sound signal to be associated with the same in the external memory 18. Further, the electronic equipment is equipped with the sound volume detection portion 111 and the speed adjustment unit 52b illustrated in FIG. 25, and a display unit and a speaker that are equivalents to the display unit 27 and the speaker 28 illustrated in FIG. 1. Then, image data of the moving image and the sound signal associated with the same recorded in the external memory 18 are preferably supplied as the image data of the input moving image and the input sound signal to the speed adjustment unit 52b and the sound volume detection portion 111 of the electronic equipment. In the electronic equipment, the display unit reproduces and displays the output moving image from the speed adjustment unit 52b at the constant frame rate of 60 fps. In this way, reproduction of the input moving image after the reproducing speed adjustment is performed on the display unit of the electronic equipment, and the sound signal associated with the input moving image is also reproduced by the speaker of the electronic equipment.

### Ninth Embodiment

A ninth embodiment of the present invention will be described. The ninth embodiment will describe still another method of realizing the recording rate varying function by the imaging apparatus 1 illustrated in FIG. 1. The descriptions described above in the individual embodiments are applied also to the ninth embodiment as long as no contradiction arises.

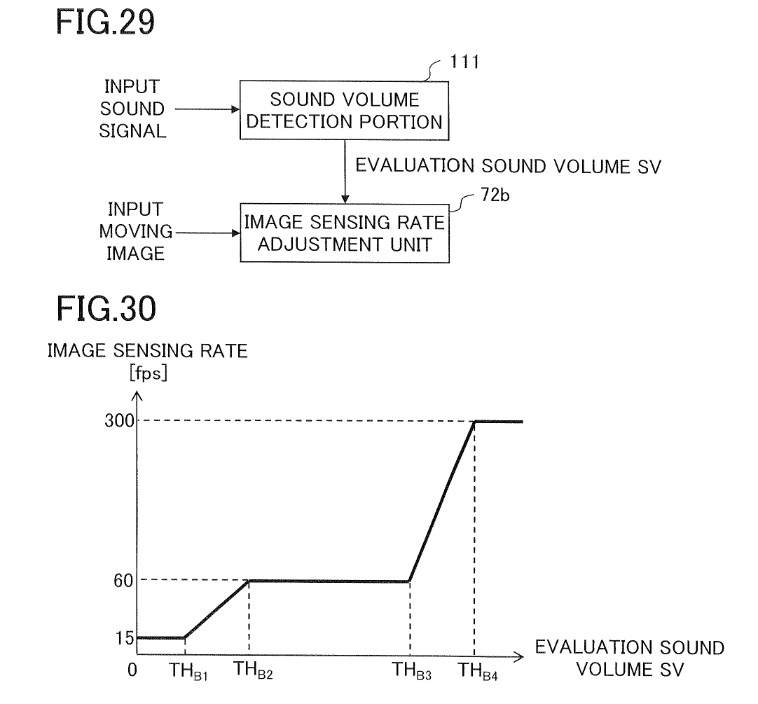

FIG. 29 is a partial block diagram of the imaging apparatus 1 related particularly to an operation in the automatic slow motion recording mode according to the ninth embodiment. The sound volume detection portion 111 illustrated in FIG. 29 is the same as that illustrated in FIG. 25. An image sensing rate adjustment unit 72b is realized, for example, by the CPU 23 and/or TG 22 illustrated in FIG. 1. The image data of the input frame image in the ninth embodiment indicates image data of the frame image output from the AFE 12 in the automatic slow motion recording mode similarly to the fourth and the fifth embodiments described above. The following description in the ninth embodiment is a description of an operation of the imaging apparatus 1 in the automatic slow motion recording mode unless otherwise described.

The input sound signal in the ninth embodiment indicates a sound signal collected by the microphone 14 illustrated in FIG. 1 in the image sensing section of the input moving image. The input sound signal and the image data of the input moving image are associated with each other and are recorded in the external memory 18. Similarly to the eighth embodiment, as illustrated in FIG. 26, it is supposed that the entire image sensing section of the input moving image is divided into a plurality of unit sections P[1], P[2], P[3], and so on.

The sound volume detection portion 111 calculates the evaluation sound volume SV of the unit section for each unit section and outputs the obtained evaluation sound volume SV to the image sensing rate adjustment unit 72b. Meaning of the evaluation sound volume SV and the method of calculating the evaluation sound volume SV are as described above in the eighth embodiment.

The image sensing rate adjustment unit 72b changes the image sensing rate dynamically based on the evaluation sound volume SV in the automatic slow motion recording mode. FIG. 30 illustrates an example of a relationship between the image sensing rate and the evaluation sound volume SV. A lookup table or a mathematical expression expressing the relationship may be given to the image sensing rate adjustment unit 72b in advance. As illustrated in FIG. 30, basically, as the evaluation sound volume SV is higher, the image sensing rate is set to a larger value.

In the example illustrated in FIG. 30, if the inequality “SV<TH_{B1}” holds, the image sensing rate is set to 15 fps. If the inequality “TH_{B1}≦SV<TH_{B2}” holds, as the evaluation sound volume SV increases from the reference sound volume TH_{B1} to the reference sound volume TH_{B2}, the image sensing rate is increased linearly from 15 fps to 60 fps. If the inequality “TH_{B2}≦SV<TH_{B3}” holds, the image sensing rate is set to 60 fps. If the inequality “TH_{B3}≦SV<TH_{B4}” holds, as the evaluation sound volume SV increases from the reference sound volume TH_{B3} to the reference sound volume TH_{B4}, the image sensing rate is increased linearly from 60 fps to 300 fps. If the inequality “TH_{B4}≦SV” holds, the image sensing rate is set to 300 fps.

If the image sensing rate can be changed continuously, the above-mentioned adjustment of the image sensing rate can be performed. Usually, however, the image sensing rate can only be changed step by step in many cases. Therefore, as the relationship illustrated in FIG. 5 is changed to the relationship illustrated in FIG. 7, the image sensing rate may be changed not continuously but by step by step in the case where the inequality “TH_{B1}≦SV<TH_{B2}” or “TH_{B3}≦SV<TH_{B4}” holds.

In the fourth or the seventh embodiment, the image sensing rate is set based on the evaluation distance DIS or the evaluation angle ANG as a quantity of state. In contrast, in the ninth embodiment, the image sensing rate is set based on the evaluation sound volume SV as another quantity of state. Except for the point that the quantity of state to be a reference for setting the image sensing rate is different, the function of the image sensing rate adjustment unit 72b is similar to the function of the image sensing rate adjustment unit 72 or 72a according to the fourth or the seventh embodiment (see FIG. 12 or FIG. 22).

However, in the ninth embodiment, it is necessary to adjust the image sensing rate in real time from the input sound signal obtained during image sensing of the input moving image. Therefore, it is difficult to reflect the detection result of the sound volume detection portion 111 in the unit section P[i] (i.e., the evaluation sound volume SV[i]) on the image sensing rate of the unit section P[i]. Therefore, the image sensing rate adjustment unit 72b adjusts the image sensing rate of the unit section after the unit section P[i] based on the evaluation sound volume SV[i]. Specifically, for example, the image sensing rate of the unit section P[i+1] is adjusted based on the evaluation sound volume SV[i]. In this case, for example, the image sensing rate with respect to the unit section P[i+1] is set to 15 fps if the inequality “SV[i]<TH_{B1}” holds. If the inequality “TH_{B2}≦SV[i]<TH_{B3}” holds, it is set to 60 fps. If the inequality “TH_{B4}≦SV[i]” holds, it is set to 300 fps.

The image data of the input moving image obtained as described above is recorded together with input sound signal in the external memory 18. In the reproducing mode, the imaging apparatus 1 reproduces the input moving image read out from the external memory 18 at a constant frame rate of 60 fps by using the display unit 27. Alternatively, it is possible to supply the input moving image recorded in the external memory 18 to other electronic equipment different from the imaging apparatus 1 (e.g., an image reproducing apparatus that is not shown), so that the electronic equipment reproduces the input moving image at a constant frame rate of 60 fps.

A part that is recorded in a state with a high image sensing rate because of a large evaluation sound volume SV is played in slow motion because of a large number of recording frames per unit time. On the contrary, a part that is recorded in a state with a low image sensing rate because of a small evaluation sound volume SV is reproduced in fast forward because of a small number of recording frames per unit time. As a result, the same effect as in the eighth embodiment can be obtained. In addition, the image sensing is performed actually at high image sensing rate (e.g., 300 fps) when the evaluation sound volume SV is large so as to record the image. Therefore, the slow motion play can be performed with high image quality compared with the eighth embodiment. On the other hand, record data quantity becomes large. In addition, when a part that is sensed at high image sensing rate (e.g., 300 fps) is reproduced by normal play, a thinning out process is necessary.

Note that, it is possible not to decrease the image sensing rate when the evaluation sound volume SV is small. In other words, for example, if the inequality “SV<TH_{B3}” holds, the image sensing rate may always be set to 60 fps even if the evaluation sound volume SV becomes so small.

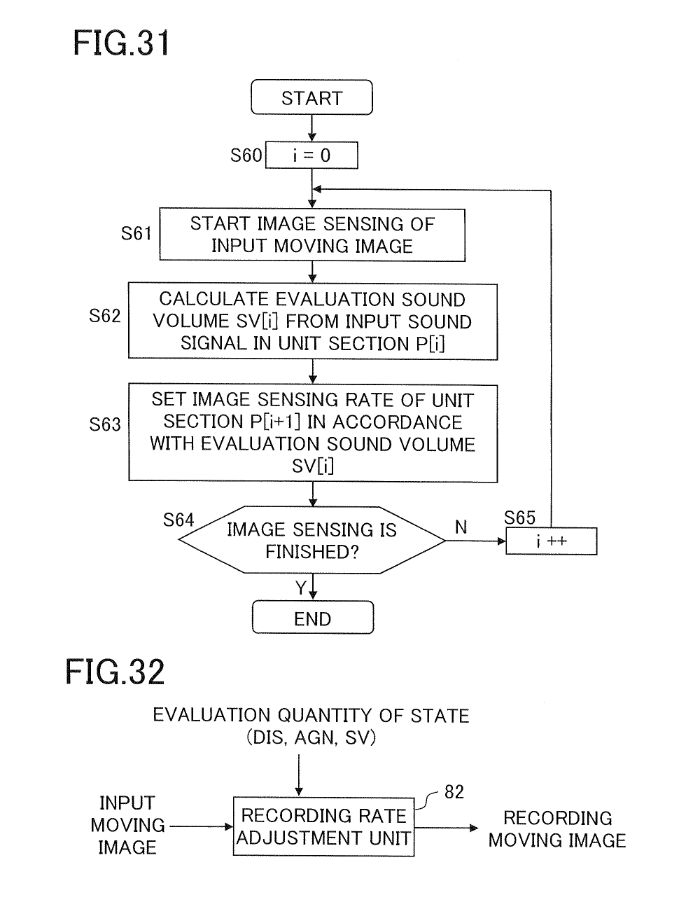

With reference to FIG. 31, an operation flow of the imaging apparatus 1 in the automatic slow motion recording mode according to ninth embodiment will be described. FIG. 31 is a flowchart illustrating this operation flow. In the automatic slow motion recording mode, when the record button 26a is pressed down for the first time so as to issue an instruction for image sensing of the input moving image, one is substituted into the variable i, and image sensing and recording of the input moving image is started (Steps S60 and S61). As described above, the input sound signal in the image sensing section of the input moving image is also associated with the image data of the input frame image and is recorded in the external memory 18. In Step S62 the evaluation sound volume SV[i] is calculated from the input sound signal in the unit section P[i], and in the next Step S63 the image sensing rate of the unit section P[i+1] is set in accordance with the evaluation sound volume SV[i]. The image data of the input frame images that are sequentially obtained are recorded continuously until image sensing of the input moving image is finished (e.g., until the record button 26a is pressed down for a second time), and the process of Step S62 and Step S63 is performed repeatedly (Step S64). Every time when the process of Step S62 and Step S63 is performed once, the variable i is incremented by one (Step S65). In addition, the image sensing rate in the unit section P[1] is fixed to 60 fps. Alternatively, it is possible to adopt a structure in which the evaluation sound volume SV[0] is calculated from the sound signal in the unit section P[0] that is a section just before the unit section P[1], and the image sensing rate in the unit section P[1] is set based on the evaluation sound volume SV[0].

Note that, as the fourth embodiment can be modified to be the fifth embodiment, the above-mentioned method in the ninth embodiment can be modified as follows.

Specifically, in the automatic slow motion recording mode, the image sensing rate is set to 60 fps for obtaining image data of the input moving image, and the image data of the input moving image and the input sound signal to be associated with the same are supplied to the speed adjustment unit 52b and the sound volume detection portion 111 illustrated in FIG. 25. Thus, the image data of the output moving image obtained from the speed adjustment unit 52b is recorded in the external memory 18. The method of generating the output moving image from the input moving image is as described above in the eighth embodiment. Then, in the reproducing mode, the imaging apparatus 1 uses the display unit 27 for reproducing the output moving image read out from the external memory 18 at a constant frame rate of 60 fps. Alternatively, the output moving image recorded in the external memory 18 is supplied to other electronic equipment different from the imaging apparatus 1 (e.g., an image reproducing apparatus that is not shown), so that the electronic equipment reproduces the output moving image at a constant frame rate of 60 fps. In this way, too, the number of frame images to be recorded per unit time is adjusted in accordance with the evaluation sound volume SV. In other words, the frame rate of the moving image to be recorded is adjusted by the speed adjustment unit 52b illustrated in FIG. 25 that is also referred to as a recording frame rate control unit or a frame rate control unit in accordance with the evaluation sound volume SV. Thus, it is possible to obtain the same effect as the case where the image sensing rate is adjusted by using the image sensing rate adjustment unit 72b illustrated in FIG. 29.

### Tenth Embodiment

A tenth embodiment of the present invention will be described. In the tenth embodiment, still another method of realizing the recording rate varying function by the imaging apparatus 1 illustrated in FIG. 1 will be described. The descriptions described above in the individual embodiments are also applied to the tenth embodiment as long as no contradiction arises.

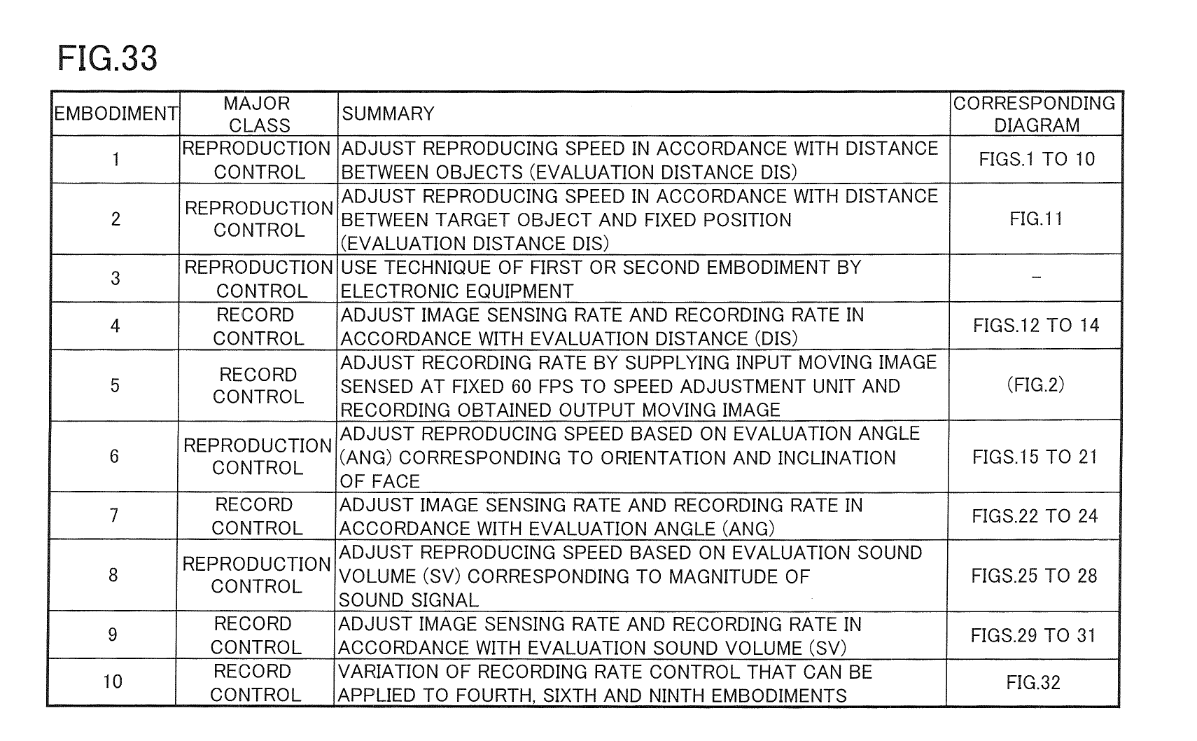

FIG. 32 is a partial block diagram of the imaging apparatus 1 related particularly to an operation in the automatic slow motion recording mode according to the tenth embodiment. A recording rate adjustment unit (recording frame rate control unit) 82 is realized by the CPU 23 illustrated in FIG. 1, for example. The following description in the tenth embodiment is a description of an operation of the imaging apparatus 1 in the automatic slow motion play mode, unless otherwise described.

In the automatic slow motion recording mode of the tenth embodiment, the image sensing rate is fixed to 300 fps, and the image data of the input moving image is obtained. On the other hand, the evaluation distance DIS, the evaluation angle ANG or the evaluation sound volume SV is derived in accordance with the method described above in any of the embodiments described above and is supplied to the recording rate adjustment unit 82. The evaluation distance DIS, the evaluation angle ANG or the evaluation sound volume SV that is supplied to the recording rate adjustment unit 82 is referred to as an evaluation quantity of state. Note that a combination of two or three of the evaluation distance DIS, the evaluation angle ANG and the evaluation sound volume SV may be the evaluation quantity of state.

The recording rate adjustment unit 82 generates a recording moving image based on the evaluation quantity of state from the input moving image. The image data of the generated recording moving image is recorded together with the input sound signal in the external memory 18.

The recording moving image is generated by thinning out a part of the input frame images if necessary, so that

the recording moving image becomes a moving image equivalent to the input moving image that is to be obtained in the fourth embodiment if the evaluation quantity of state is the evaluation distance DIS (see FIG. 12 and FIG. 13), and

the recording moving image becomes a moving image equivalent to the input moving image that is to be obtained in the seventh embodiment if the evaluation quantity of state is the evaluation angle ANG (see FIG. 22 and FIG. 23), and

the recording moving image becomes a moving image equivalent to the input moving image that is to be obtained in the ninth embodiment if the evaluation quantity of state is the evaluation sound volume SV (see FIG. 29 and FIG. 30).

For a specific description, an operation in the case where the evaluation quantity of state is the evaluation sound volume SV will be described. In addition, it is supposed that the number of the input frame images belonging to each unit section (i.e., a value of L) is 20 (i.e., the time length of each unit section is 20× 1/300= 1/15 seconds), and the j-th input frame image in the unit section P[i] is expressed by FI[i, j] (i and j are integers). In this case, the recording moving image in the unit section P[i] is formed of a whole or a part of the input frame images FI[i, 1] to FI[i, 20]. Basically, as the evaluation sound volume SV[i] is higher, the number of input frame images forming the recording moving image in the unit section P[i] is increased.

Specifically, for example (see FIG. 30),

the input frame image forming the recording moving image in the unit section P[i] is,

only FI[i, 1] if the inequality “SV[i]<TH_{B1}” holds,

only FI[i, 1] and FI[i, 11] if the inequality “TH_{B1}≦SV[i]<TH_{B2}” holds,

only FI[i, 1], FI[i, 6], FI[i, 11] and FI[i, 16] if the inequality “TH_{B2}≦SV<TH_{B3}” holds, only FI[i, 1], H[i, 3], FI[i, 5], FI[i, 7], FI[i, 9], FI[i, 11], FI[i, 13], FI[i, 15], FI[i, 17] and FI[i, 19] if the inequality “TH_{B3}≦SV<TH_{B4}” holds, and

all the FI[i, 1] to FI[i, 20] if the inequality “TH_{B4}≦SV” holds.

In the reproducing mode, the imaging apparatus 1 uses the display unit 27 for reproducing the recording moving image read out from the external memory 18 at the constant frame rate of 60 fps. Alternatively, it is possible to supply the recording moving image recorded in the external memory 18 to other electronic equipment different from the imaging apparatus 1 (e.g., an image reproducing apparatus that is not shown), so that the electronic equipment reproduces the recording moving image at the constant frame rate of 60 fps. In this way, the same effect can be obtained as in the fourth, the seventh or the ninth embodiment, in which the image sensing rate is controlled in accordance with the evaluation quantity of state.

Variations

Specific numerical values in the above description are merely examples, which can be changed to various values as a matter of course.

The imaging apparatus 1 illustrated in FIG. 1 may be constituted by hardware or a combination of hardware and software. If software is used for constituting the imaging apparatus 1, the block diagram of each part realized by the software represents a functional block diagram of the part. The function realized by software may be described as a program, and a program executing device (e.g., a computer) may execute the program so as to realize the function.

What is claimed is:

1. An image reproducing apparatus which reproduces a moving image, comprising a reproducing speed control unit which controls a reproducing speed of the moving image in accordance with an evaluation distance that is a distance between a plurality of specific objects in the moving image or a distance between a fixed position and a target object in the moving image.

2. An image reproducing apparatus according to claim 1, wherein the reproducing speed control unit performs tracking of a position of each of the specific objects in the moving image based on image data of the moving image so as to derive the distance between the plurality of specific objects as the evaluation distance, or performs tracking of a position of the target object in the moving image based on the image data of the moving image so as to derive the distance between the fixed position and the target object as the evaluation distance.

3. An image reproducing apparatus which reproduces a moving image, comprising a reproducing speed control unit which controls a reproducing speed of the moving image in accordance with at least one of orientation and inclination of a person's face in the moving image.

4. An image reproducing apparatus which reproduces a moving image, comprising a reproducing speed control unit which controls a reproducing speed of the moving image in accordance with a magnitude of a sound signal associated with the moving image.

5. An imaging apparatus comprising the image reproducing apparatus according to claim 1, wherein the moving image to be reproduced by the image reproducing apparatus is obtained by image sensing.

6. An imaging apparatus comprising the image reproducing apparatus according to claim 3, wherein the moving image to be reproduced by the image reproducing apparatus is obtained by image sensing.

7. An imaging apparatus comprising the image reproducing apparatus according to claim 4, wherein the moving image to be reproduced by the image reproducing apparatus is obtained by image sensing.

8. An imaging apparatus which performs image sensing and recording of a moving image, comprising a frame rate control unit which controls a frame rate of the moving image to be recorded in accordance with an evaluation distance that is a distance between a plurality of specific objects in the moving image or a distance between a fixed position and a target object in the moving image.

9. An imaging apparatus according to claim 8, wherein the frame rate control unit performs tracking of a position of each of the specific objects in the moving image based on image data of the moving image so as to derive the distance between the plurality of specific objects as the evaluation distance, or performs tracking of a position of the target object in the moving image based on the image data of the moving image so as to derive the distance between the fixed position and the target object as the evaluation distance.

10. An imaging apparatus which performs image sensing and recording of a moving image, comprising a frame rate control unit which controls a frame rate of the moving image to be recorded in accordance with at least one of orientation and inclination of a person's face in the moving image.

11. An imaging apparatus which performs image sensing and recording of a moving image, comprising a frame rate control unit which controls a frame rate of the moving image to be recorded in accordance with a magnitude of a sound signal collected when the image sensing of the moving image is performed.

12. An imaging apparatus according to claim 8, wherein the recorded moving image is output to a display unit at a constant frame rate.

13. An imaging apparatus according to claim 10, wherein the recorded moving image is output to a display unit at a constant frame rate.

14. An imaging apparatus according to claim 11, wherein the recorded moving image is output to a display unit at a constant frame rate.
